(19) United States
(12) Patent Application Publication
(10) Pub. No.: US 2017/0247606 A1
(43) Pub. Date: Aug. 31, 2017

(54) SILICA CROSSLINKER INCLUDING BORONIC ACID FUNCTIONALITIES OR ESTERS THEREOF FOR TREATMENT OF SUBTERRANEAN FORMATIONS

(71) Applicant: Halliburton Energy Services, Inc., Houston, TX (US)

(72) Inventors: Rajender Salla, Pune (IN); Vikesh Singh Baghel, Pune (IN); Philip D. Nguyen, Houston, TX (US)

(73) Assignee: Halliburton Energy Services, Inc., Houston, TX (US)

(21) Appl. No.: 15/508,029

(22) PCT Filed: Nov. 19, 2014
(86) PCT No.: PCT/US2014/066365

§ 371 Date: Mar. 1, 2017

(51) Int. Cl. C09K 8/68; C09K 8/88; C09K 8/90; C09K 8/08

(52) U.S. Cl. CPC C09K 8/685; C09K 8/08; C09K 8/887; C09K 8/90; C09K 2208/10

(57) ABSTRACT

Various embodiments disclosed relate to crosslinkers for treatment of a subterranean formation and methods of using the same. In various embodiments, the present invention provides a method of treating a subterranean formation. The method includes placing in a subterranean formation a composition that includes polysaccharide viscosifier. The composition also includes a crosslinker including a silica bonded to at least one crosslinking group that includes at least one amine group including at least one of a boronic acid and an ester thereof.

### BACKGROUND

During the drilling, completion, and production phases of wells for petroleum, the downhole use of compositions having higher viscosities is important for a wide variety of purposes. Such fluids can more effectively carry materials (e.g., proppants, gravel, and the like) to a desired location downhole. Similarly, such fluids can more effectively carry materials away from a drilling location downhole. Further, the use of such fluids during hydraulic fracturing generally results in larger, more dominant fractures.

### BRIEF DESCRIPTION OF THE FIGURES

The drawings illustrate generally, by way of example, but not by way of limitation, various embodiments discussed in the present document.

FIG. 1 illustrates a drilling assembly, in accordance with various embodiments.

FIG. 2 illustrates a system or apparatus for delivering a composition to a subterranean formation, in accordance with various embodiments.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. A comma can be used as a delimiter or digit group separator to the left or right of a decimal mark; for example, “0.000,1” is equivalent to “0.0001.”

In the methods of manufacturing described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, within 1%, or within 0% of a stated value or of a stated limit of a range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

The term “organic group” as used herein refers to but is not limited to any carbon-containing functional group. For example, an oxygen-containing group such as an alkoxy group, aryloxy group, aralkyloxy group, oxo(carbonyl) group, a carboxyl group including a carboxylic acid, carboxylate, and a carboxylate ester; a sulfur-containing group such as an alkyl and aryl sulfide group; and other heteroatom-containing groups. Non-limiting examples of organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, or C(═NOR)R, wherein R can be hydrogen (in examples that include other carbon atoms) or a carbon-based moiety, and wherein the carbon-based moiety can itself be further substituted.

The term “substituted” as used herein refers to an organic group as defined herein or molecule in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents J that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, or C(═NOR)R, wherein R can be hydrogen or a carbon-based moiety; for example, R can be hydrogen, alkyl, acyl, cycloalkyl, aryl, aralkyl, heterocyclyl, heteroaryl, or heteroarylalkyl.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to 40 carbon atoms, or 2 to about 20 carbon atoms, or 2 to 12 carbons or, in some embodiments, from 2 to 8 carbon atoms. Examples include, but are not limited to vinyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “acyl” as used herein refers to a group containing a carbonyl moiety wherein the group is bonded via the carbonyl carbon atom. The carbonyl carbon atom is also bonded to another carbon atom, which can be part of an alkyl, aryl, aralkyl cycloalkyl, cycloalkylalkyl, heterocyclyl, heterocyclylalkyl, heteroaryl, heteroarylalkyl group or the like. In the special case wherein the carbonyl carbon atom is bonded to a hydrogen, the group is a “formyl” group, an acyl group as the term is defined herein. An acyl group can include 0 to about 12-20 or 12-40 additional carbon atoms bonded to the carbonyl group. An acyl group can include double or triple bonds within the meaning herein. An acryloyl group is an example of an acyl group. An acyl group can also include heteroatoms within the meaning here. A nicotinoyl group (pyridyl-3-carbonyl) is an example of an acyl group within the meaning herein. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group.

The term “aryl” as used herein refers to cyclic aromatic hydrocarbons that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, 2-, 3-, 4-, 5-, or 6-substituted phenyl or 2-8 substituted naphthyl groups, which can be substituted with carbon or non-carbon groups such as those listed herein.

The term “heterocyclyl” as used herein refers to aromatic and non-aromatic ring compounds containing three or more ring members, of which one or more is a heteroatom such as, but not limited to, N, O, and S.

The term “alkoxy” as used herein refers to an oxygen atom connected to an alkyl group, including a cycloalkyl group, as are defined herein. Examples of linear alkoxy groups include but are not limited to methoxy, ethoxy, propoxy, butoxy, pentyloxy, hexyloxy, and the like. Examples of branched alkoxy include but are not limited to isopropoxy, sec-butoxy, tert-butoxy, isopentyloxy, isohexyloxy, and the like. Examples of cyclic alkoxy include but are not limited to cyclopropyloxy, cyclobutyloxy, cyclopentyloxy, cyclohexyloxy, and the like. An alkoxy group can include one to about 12-20 or about 12-40 carbon atoms bonded to the oxygen atom, and can further include double or triple bonds, and can also include heteroatoms. For example, an allyloxy group is an alkoxy group within the meaning herein. A methoxyethoxy group is also an alkoxy group within the meaning herein, as is a methylenedioxy group in a context where two adjacent atoms of a structure are substituted therewith.

The term “amine” as used herein refers to primary, secondary, and tertiary amines having, e.g., the formula N(group)₃ wherein each group can independently be H or non-H, such as alkyl, aryl, and the like. Amines include but are not limited to R—NH₂, for example, alkylamines, arylamines, alkylarylamines; R₂NH wherein each R is independently selected, such as dialkylamines, diarylamines, aralkylamines, heterocyclylamines and the like; and R₃N wherein each R is independently selected, such as trialkylamines, dialkylarylamines, alkyldiarylamines, triarylamines, and the like. The term “amine” also includes ammonium ions as used herein.

The term “amino group” as used herein refers to a substituent of the form —NH₂, —NHR, —NR₂, —NR₃⁺, wherein each R is independently selected, and protonated forms of each, except for —NR₃⁺, which cannot be protonated. Accordingly, any compound substituted with an amino group can be viewed as an amine. An “amino group” within the meaning herein can be a primary, secondary, tertiary, or quaternary amino group. An “alkylamino” group includes a monoalkylamino, dialkylamino, and trialkylamino group.

The terms “halo,” “halogen,” or “halide” group, as used herein, by themselves or as part of another substituent, mean, unless otherwise stated, a fluorine, chlorine, bromine, or iodine atom.

The term “haloalkyl” group, as used herein, includes mono-halo alkyl groups, poly-halo alkyl groups wherein all halo atoms can be the same or different, and per-halo alkyl groups, wherein all hydrogen atoms are replaced by halogen atoms, such as fluoro. Examples of haloalkyl include trifluoromethyl, 1,1-dichloroethyl, 1,2-dichloroethyl, 1,3-dibromo-3,3-difluoropropyl, perfluorobutyl, and the like.

The term “hydrocarbon” as used herein refers to a functional group or molecule that includes carbon and hydrogen atoms. The term can also refer to a functional group or molecule that normally includes both carbon and hydrogen atoms but wherein all the hydrogen atoms are substituted with other functional groups.

As used herein, the term “hydrocarbyl” refers to a functional group derived from a straight chain, branched, or cyclic hydrocarbon, and can be alkyl, alkenyl, alkynyl, aryl, cycloalkyl, acyl, or any combination thereof.

The term “solvent” as used herein refers to a liquid that can dissolve a solid, liquid, or gas. Non-limiting examples of solvents are silicones, organic compounds, water, alcohols, ionic liquids, and supercritical fluids.

The term “room temperature” as used herein refers to a temperature of about 15° C. to 28° C.

The term “standard temperature and pressure” as used herein refers to 20° C. and 101 kPa.

As used herein, “degree of polymerization” is the number of repeating units in a polymer.

As used herein, the term “polymer” refers to a molecule having at least one repeating unit and can include copolymers.

The term “copolymer” as used herein refers to a polymer that includes at least two different repeating units. A copolymer can include any suitable number of repeating units.

The term “downhole” as used herein refers to under the surface of the earth, such as a location within or fluidly connected to a wellbore.

As used herein, the term “drilling fluid” refers to fluids, slurries, or muds used in drilling operations downhole, such as during the formation of the wellbore.

As used herein, the term “stimulation fluid” refers to fluids or slurries used downhole during stimulation activities of the well that can increase the production of a well, including perforation activities. In some examples, a stimulation fluid can include a fracturing fluid or an acidizing fluid.

As used herein, the term “clean-up fluid” refers to fluids or slurries used downhole during clean-up activities of the well, such as any treatment to remove material obstructing the flow of desired material from the subterranean formation. In one example, a clean-up fluid can be an acidification treatment to remove material formed by one or more perforation treatments. In another example, a clean-up fluid can be used to remove a filter cake.

As used herein, the term “fracturing fluid” refers to fluids or slurries used downhole during fracturing operations.

As used herein, the term “spotting fluid” refers to fluids or slurries used downhole during spotting operations, and can be any fluid designed for localized treatment of a downhole region. In one example, a spotting fluid can include a lost circulation material for treatment of a specific section of the wellbore, such as to seal off fractures in the wellbore and prevent sag. In another example, a spotting fluid can include a water control material. In some examples, a spotting fluid can be designed to free a stuck piece of drilling or extraction equipment, can reduce torque and drag with drilling lubricants, prevent differential sticking, promote wellbore stability, and can help to control mud weight.

As used herein, the term “completion fluid” refers to fluids or slurries used downhole during the completion phase of a well, including cementing compositions.

As used herein, the term “remedial treatment fluid” refers to fluids or slurries used downhole for remedial treatment of a well. Remedial treatments can include treatments designed to increase or maintain the production rate of a well, such as stimulation or clean-up treatments.

As used herein, the term “abandonment fluid” refers to fluids or slurries used downhole during or preceding the abandonment phase of a well.

As used herein, the term “acidizing fluid” refers to fluids or slurries used downhole during acidizing treatments. In one example, an acidizing fluid is used in a clean-up operation to remove material obstructing the flow of desired material, such as material formed during a perforation operation. In some examples, an acidizing fluid can be used for damage removal.

As used herein, the term “cementing fluid” refers to fluids or slurries used during cementing operations of a well. For example, a cementing fluid can include an aqueous mixture including at least one of cement and cement kiln dust. In another example, a cementing fluid can include a curable resinous material such as a polymer that is in an at least partially uncured state.

As used herein, the term “water control material” refers to a solid or liquid material that interacts with aqueous material downhole, such that hydrophobic material can more easily travel to the surface and such that hydrophilic material (including water) can less easily travel to the surface. A water control material can be used to treat a well to cause the proportion of water produced to decrease and to cause the proportion of hydrocarbons produced to increase, such as by selectively binding together material between water-producing subterranean formations and the wellbore while still allowing hydrocarbon-producing formations to maintain output.

As used herein, the term “packer fluid” refers to fluids or slurries that can be placed in the annular region of a well between tubing and outer casing above a packer. In various examples, the packer fluid can provide hydrostatic pressure in order to lower differential pressure across the sealing element, lower differential pressure on the wellbore and casing to prevent collapse, and protect metals and elastomers from corrosion.

As used herein, the term “fluid” refers to liquids and gels, unless otherwise indicated.

As used herein, the term “subterranean material” or “subterranean formation” refers to any material under the surface of the earth, including under the surface of the bottom of the ocean. For example, a subterranean formation or material can be any section of a wellbore and any section of a subterranean petroleum- or water-producing formation or region in fluid contact with the wellbore. Placing a material in a subterranean formation can include contacting the material with any section of a wellbore or with any subterranean region in fluid contact therewith. Subterranean materials can include any materials placed into the wellbore such as cement, drill shafts, liners, tubing, casing, or screens; placing a material in a subterranean formation can include contacting with such subterranean materials. In some examples, a subterranean formation or material can be any below-ground region that can produce liquid or gaseous petroleum materials, water, or any section below-ground in fluid contact therewith. For example, a subterranean formation or material can be at least one of an area desired to be fractured, a fracture or an area surrounding a fracture, and a flow pathway or an area surrounding a flow pathway, wherein a fracture or a flow pathway can be optionally fluidly connected to a subterranean petroleum- or water-producing region, directly or through one or more fractures or flow pathways.

As used herein, “treatment of a subterranean formation” can include any activity directed to extraction of water or petroleum materials from a subterranean petroleum- or water-producing formation or region, for example, including drilling, stimulation, hydraulic fracturing, clean-up, acidizing, completion, cementing, remedial treatment, abandonment, and the like.

As used herein, a “flow pathway” downhole can include any suitable subterranean flow pathway through which two subterranean locations are in fluid connection. The flow pathway can be sufficient for petroleum or water to flow from one subterranean location to the wellbore or vice-versa. A flow pathway can include at least one of a hydraulic fracture, and a fluid connection across a screen, across gravel pack, across proppant, including across resin-bonded proppant or proppant deposited in a fracture, and across sand. A flow pathway can include a natural subterranean passageway through which fluids can flow. In some embodiments, a flow pathway can be a water source and can include water. In some embodiments, a flow pathway can be a petroleum source and can include petroleum. In some embodiments, a flow pathway can be sufficient to divert from a wellbore, fracture, or flow pathway connected thereto at least one of water, a downhole fluid, or a produced hydrocarbon.

As used herein, a “carrier fluid” refers to any suitable fluid for suspending, dissolving, mixing, or emulsifying with one or more materials to form a composition. For example, the carrier fluid can be at least one of crude oil, dipropylene glycol methyl ether, dipropylene glycol dimethyl ether, dipropylene glycol methyl ether, dipropylene glycol dimethyl ether, dimethyl formamide, diethylene glycol methyl ether, ethylene glycol butyl ether, diethylene glycol butyl ether, butylglycidyl ether, propylene carbonate, D-limonene, a C₂-C₄₀ fatty acid C₁-C₁₀ alkyl ester (e.g., a fatty acid methyl ester), tetrahydrofurfuryl methacrylate, tetrahydrofurfuryl acrylate, 2-butoxy ethanol, butyl acetate, butyl lactate, furfuryl acetate, dimethyl sulfoxide, dimethyl formamide, a petroleum distillation product of fraction (e.g., diesel, kerosene, napthas, and the like) mineral oil, a hydrocarbon oil, a hydrocarbon including an aromatic carbon-carbon bond (e.g., benzene, toluene), a hydrocarbon including an alpha olefin, xylenes, an ionic liquid, methyl ethyl ketone, an ester of oxalic, maleic or succinic acid, methanol, ethanol, propanol (iso- or normal-), butyl alcohol (iso-, tert-, or normal-), an aliphatic hydrocarbon (e.g., cyclohexanone, hexane), water, brine, produced water, flowback water, brackish water, and sea water. The fluid can form about 0.001 wt % to about 99.999 wt % of a composition, or a mixture including the same, or about 0.001 wt % or less, 0.01 wt %, 0.1, 1, 2, 3, 4, 5, 6, 8, 10, 15, 20, 25, 30, 35, 40, 45, 50, 55, 60, 65, 70, 75, 80, 85, 90, 95, 96, 97, 98, 99, 99.9, 99.99, or about 99.999 wt % or more.

In various embodiments, the present invention provides a method of treating a subterranean formation. The method includes placing in a subterranean formation a composition including a polysaccharide viscosifier. The composition also includes a crosslinker including a silica bonded to at least one crosslinking group. The crosslinking group includes at least one amine group including at least one of a boronic acid and an ester thereof.

In various embodiments, the present invention provides a method of treating a subterranean formation. The method includes placing in a subterranean formation a composition including a polysaccharide viscosifier. The composition also includes a nanoparticle crosslinker including a silica bonded to at least one crosslinking group. The silica bonded to the crosslinking group has the structure:

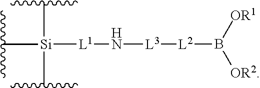

The variable L¹ is chosen from a bond and a substituted or unsubstituted (C₁-C₂₀)hydrocarbylene interrupted with 0, 1, 2, or 3 groups independently chosen from —O—, —S—, and substituted or unsubstituted —NH—. The variable L² is chosen from a bond and a substituted or unsubstituted (C₁-C₂₀)hydrocarbylene linker interrupted with 0, 1, 2, or 3 groups independently chosen from —O—, —S—, and substituted or unsubstituted —NH—. The variable L³ is chosen from a bond, a —(NH—(C₁-C₅)alkyl)ₙ- group, and a —(C₁-C₅)alkyl-(NH—(C₁-C₅)alkyl)ₙ- group, wherein n is about 1 to about 10,000. The variables R¹ and R² are each independently selected from —H and substituted or unsubstituted (C₁-C₂₀)hydrocarbyl interrupted by 0, 1, 2, or 3 groups independently chosen from —O—, —S—, and substituted or unsubstituted —NH—, or wherein R¹ and R² together form a substituted or unsubstituted (C₁-C₂₀)hydrocarbylene interrupted by 0, 1, 2, or 3 groups independently chosen from —O—, —S—, and substituted or unsubstituted —NH—. The method also includes crosslinking the polysaccharide viscosifier with the nanoparticle crosslinker.

In various embodiments, the present invention provides a system that includes a composition that includes a polysaccharide viscosifier. The composition also includes a crosslinker including a silica bonded to at least one crosslinking group that includes at least one amine group including at least one of a boronic acid and an ester thereof. The system also includes a subterranean formation including the composition therein.

In various embodiments, the present invention provides a composition for treatment of a subterranean formation. The composition includes a polysaccharide viscosifier. The composition also includes a crosslinker including a silica bonded to at least one crosslinking group that includes at least one amine group including at least one of a boronic acid and an ester thereof.

In various embodiments, the present invention provides a composition for treatment of a subterranean formation. The composition includes a polysaccharide viscosifier. The composition also includes a nanoparticle crosslinker including a silica bonded to at least one crosslinking group. The silica bonded to the crosslinking group has the structure:

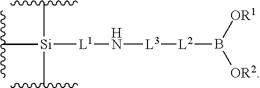

The variable L¹ is chosen from a bond and a substituted or unsubstituted (C₁-C₂₀)hydrocarbylene interrupted with 0, 1, 2, or 3 groups independently chosen from —O—, —S—, and substituted or unsubstituted —NH—. The variable L² is chosen from a bond and a substituted or unsubstituted (C₁-C₂₀)hydrocarbylene linker interrupted with 0, 1, 2, or 3 groups independently chosen from —O—, —S—, and substituted or unsubstituted —NH—. The variable L³ is chosen from a bond, a —(NH—(C₁-C₅)alkyl)ₙ- group, and a —(C₁-C₅)alkyl-(NH—(C₁-C₅)alkyl)ₙ- group, wherein n is about 1 to about 10,000. The variables R¹ and R² are each independently selected from —H and substituted or unsubstituted (C₁-C₂₀)hydrocarbyl interrupted by 0, 1, 2, or 3 groups independently chosen from —O—, —S—, and substituted or unsubstituted —NH—, or wherein R and R² together form a substituted or unsubstituted (C₁-C₂₀)hydrocarbylene interrupted by 0, 1, 2, or 3 groups independently chosen from —O—, —S—, and substituted or unsubstituted —NH—.

In various embodiments, the present invention provides a method of preparing a composition for treatment of a subterranean formation. The method includes forming a composition including a polysaccharide viscosifier. The composition also includes a crosslinker including a silica bonded to at least one crosslinking group that includes at least one amine group including at least one of a boronic acid and an ester thereof.

In various embodiments, the crosslinker has certain advantages over other crosslinkers, at least some of which are unexpected. For example, in various embodiments, due at least in part to an ability to crosslink at multiple boron sites per molecule, the crosslinker can provide a higher degree of crosslinking and a correspondingly greater viscosity increase per unit mass of viscosifier as compared to other crosslinkers. In various embodiments, less viscosifier can be used to achieve a desired increase in viscosity, providing cost savings over other compositions and methods of using the same. For example, in some embodiments, about 5 times less (by mass) viscosifier can be needed to produce a particular increase in viscosity as compared to the amount of the viscosifier required when crosslinked by another crosslinker, or 10 times less, 15 times less, 20 times less, 25 times less, or 30 times less, or more than 30 times less. In various embodiments, a smaller total amount of crosslinker is needed to crosslink a given amount of viscosifier to provide a particular viscosity increase, allowing use of less crosslinker to provide a desired viscosity increase as compared to other crosslinkers. For example, in some embodiments, about 5 times less (by mass) crosslinker can be needed to produce a particular increase in viscosity using a given amount of viscosifier as compared to the amount of the crosslinker required when another crosslinker is used, or 10 times less, 15 times less, 20 times less, 25 times less, or 30 times less, or more than 30 times less. In various embodiments, the use of a smaller amount of crosslinker provides cost savings over other crosslinkers and methods of using the same.

In various embodiments, a viscosifier crosslinked with the crosslinker can have a comparable or improved ability to maintain increased viscosities during high temperature conditions, as compared to other viscosifiers crosslinked with other crosslinkers. In various embodiments, by providing better viscosification under extreme thermal conditions, less viscosifier and crosslinker is needed to provide a given viscosity under high temperature conditions than required using other crosslinkers, providing cost savings.

In various embodiments, the crosslinker can be more friendly toward health and the environment than other crosslinkers. In various embodiments, the crosslinker can be prepared from starting materials that are more friendly toward health and the environment than other crosslinkers. In various embodiments, the crosslinker can be prepared more conveniently than other crosslinkers, such as at least one of at lower temperatures and over a shorter time. For example, some crosslinkers are toxic latex nanoparticles (e.g., organic material), which are difficult to prepare and use toxic starting materials such as styrenes, and can require several days to synthesize. Some crosslinkers are toxic tetraethylpentamine-derived particles (e.g., organic material), which are derived from toxic tetraethylpentamine starting materials, and require heating at about 150° C. for synthesis. In various embodiments, in contrast, the crosslinker can be silica-based (e.g., inorganic), can use silyl alkyl amine starting materials which can be environmentally- and health-friendly, and can be synthesized in only a few hours at room temperature.

In various embodiments, the crosslinker can be easily configured to provide delayed crosslinking over a desired period under a broad variety of subterranean conditions. In some embodiments, the crosslinker can be encapsulated to provide a desired delay in crosslinking. In some embodiments, the delayed crosslinking can help to lower the friction pressure during high injection rates, especially high injection rates required in hydraulic treatments in unconventional formations. In various embodiments, such as including gravel packing operations, the crosslinker can be configured such that a desired viscosity is attained quickly such that the gravel can be suspended, wherein little to no delayed crosslinking occurs. In various embodiments, the crosslinker can be prepared at lower cost than other crosslinkers. In some embodiments, the crosslinker can include a payload material, such as in a hollow interior of the silica or in pores of the silica, providing delayed or extended release of materials in a manner that is not possible with other crosslinkers. For example, in some embodiments, the pores or an interior of the silica crosslinker can include a breaker activator, an organic acid, a chelator (e.g., a chelator that chelates metal ions), or a corrosion inhibitor, which can be released at a desired time and location. In various embodiments, the crosslinker can include Fe₂O₃.

### Method of Treating a Subterranean Formation.

In some embodiments, the present invention provides a method of treating a subterranean formation. The method includes placing a composition including a polysaccharide viscosifier and a crosslinker including a silica bonded to at least one crosslinking group in a subterranean formation. The crosslinking group bonded to the silica includes at least one amine group including at least one of a boronic acid and an ester thereof. The placing of the composition in the subterranean formation can include contacting the composition and any suitable part of the subterranean formation, or contacting the composition and a subterranean material, such as any suitable subterranean material. The subterranean formation can be any suitable subterranean formation. In some examples, the placing of the composition in the subterranean formation includes contacting the composition with or placing the composition in at least one of a fracture, at least a part of an area surrounding a fracture, a flow pathway, an area surrounding a flow pathway, and an area desired to be fractured. The placing of the composition in the subterranean formation can be any suitable placing and can include any suitable contacting between the subterranean formation and the composition. The placing of the composition in the subterranean formation can include at least partially depositing the composition in a fracture, flow pathway, or area surrounding the same. In some embodiments, the method includes obtaining or providing the composition including the polysaccharide viscosifier and the silica crosslinker (e.g., mixing the polysaccharide viscosifier and the silica crosslinker together, or mixing either one or both of these components with another component of the composition). The obtaining or providing of the composition can occur at any suitable time and at any suitable location. The obtaining or providing of the composition can occur above the surface. The obtaining or providing of the composition can occur in the subterranean formation (e.g., downhole).

The method can include hydraulic fracturing, such as a method of hydraulic fracturing to generate a fracture or flow pathway. The placing of the composition in the subterranean formation or the contacting of the subterranean formation and the hydraulic fracturing can occur at any time with respect to one another; for example, the hydraulic fracturing can occur at least one of before, during, and after the contacting or placing. In some embodiments, the contacting or placing occurs during the hydraulic fracturing, such as during any suitable stage of the hydraulic fracturing, such as during at least one of a pre-pad stage (e.g., during injection of water with no proppant, and additionally optionally mid- to low-strength acid), a pad stage (e.g., during injection of fluid only with no proppant, with some viscosifier, such as to begin to break into an area and initiate fractures to produce sufficient penetration and width to allow proppant-laden later stages to enter), or a slurry stage of the fracturing (e.g., viscous fluid with proppant). The method can include performing a stimulation treatment at least one of before, during, and after placing the composition in the subterranean formation in the fracture, flow pathway, or area surrounding the same. The stimulation treatment can be, for example, at least one of perforating, acidizing, injecting of cleaning fluids, propellant stimulation, and hydraulic fracturing. In some embodiments, the stimulation treatment at least partially generates a fracture or flow pathway where the composition is placed or contacted, or the composition is placed or contacted to an area surrounding the generated fracture or flow pathway.

In some embodiments, the method can be a method of drilling, stimulation, fracturing, spotting, clean-up, completion, remedial treatment, applying a pill, acidizing, cementing, packing, spotting, or a combination thereof. In some embodiments, the method can be a method of gravel packing, for example, the composition can include gravel which can be carried in a viscous gel during sand control operations. The gravel packing operation can form a gravel pack that can effectively function as a filter to prevent or reduce the production of unwanted formation sand. In some embodiments, a screen can be placed in the wellbore to control the placement of gravel, such as in an annulus between the screen and the casing which can include perforations.

In some embodiments, the method further includes crosslinking the polysaccharide viscosifier with the silica crosslinker. The crosslinking can occur at least one of above-surface and downhole. The crosslinking can be triggered by the effects of heat, time, pressure, vibration, chemicals, any other suitable crosslinking trigger, or a combination thereof.

In some embodiments, the composition can include proppant or gravel. In some embodiments, the proppant or gravel can include a coating of the silica crosslinker. The coated proppant or gravel can be exposed to a solution including a polysaccharide viscosifier, such that crosslinked polysaccharide viscosifier forms around the coated proppant or gravel. The crosslinking can occur downhole, above-surface, or a combination thereof. In various embodiments, the proppant or gravel coated with crosslinked viscosifier (e.g., hydrated gel) can have advantageous buoyancy characteristics, such as neutral buoyancy in aqueous solution, which can help to suspend the proppant or gravel more easily during subterranean operations. Various embodiments of the method can include placing the crosslinker-coated proppant or gravel downhole, or placing the crosslinked viscosifier-coated proppant or gravel downhole.

### Crosslinker.

The composition includes a crosslinker. The crosslinker includes a silica bonded to at least one crosslinking group, and can be referred to as a silica crosslinker. The composition can include one or more silica crosslinkers. The crosslinking group includes at least one amine group including at least one of a boronic acid and an ester thereof. The crosslinker can form any suitable proportion of the composition, such that the composition can be used as described herein. In some embodiments, the one or more silica crosslinkers can be about 0.000,1 wt % to about 30 wt % of the composition, or about 0.001 wt % to about 10 wt % of the composition, or about 0.000,1 wt % or less, or about 0.000,5 wt %, 0.001, 0.005, 0.01, 0.05, 0.1, 0.5, 1, 1.5, 2, 2.5, 3, 3.5, 4, 4.5, 5, 6, 7, 8, 9, 10, 12, 14, 16, 18, 20, 25, or about 30 wt % or more. In some embodiments, the silica crosslinker in the composition is not crosslinked with the polysaccharide viscosifier. In other embodiments, the composition can include a polysaccharide viscosifier that has been crosslinked with the crosslinker (e.g., a crosslinked reaction product of a composition including the polysaccharide viscosifier and the silica crosslinker, such that the silica crosslinker is incorporated in a crosslinked polysaccharide polymer network). In various embodiments, the silica crosslinker can be encapsulated or otherwise formulated to provide delayed-crosslinking or to provide crosslinking over an extended period of time. Any suitable material or technique can be used to provide encapsulation or formation for delayed-crosslinking or extended-time crosslinking.

The silica can be a silica core, with the crosslinking groups bonded thereto. The silica can be a hollow shell in the crosslinker, with crosslinking groups bonded on the inside, on the outside, or a combination thereof. The silica can be any suitable one or more types of silica, such as at least one of fused quartz, crystalline silica, fumed silica, silica gel, and an aerogel. The silica can be mesoporous silica. The silica can include a network of silicon atoms connected via oxygen atoms (e.g., Si—O—Si), wherein the network can terminate in any suitable fashion, such as Si—OH or Si—O-substituent. In some embodiments, the silica includes iron oxide (e.g., FeO, Fe₃O₄, Fe₄O₅, or Fe₂O₃), such as an iron oxide core.

The silica crosslinker can have any suitable number of crosslinking groups on the silica. For example, the crosslinker can have about 1 to about 100,000 crosslinker groups (e.g., crosslinker groups having boronic acid or boronate ester groups thereon), or about 25 to about 1,000 crosslinker groups, or about 1, 5, 10, 20, 30, 40, 50, 60, 70, 80, 90, 100, 125, 150, 175, 200, 225, 250, 275, 300, 325, 350, 375, 400, 425, 450, 475, 500, 525, 550, 575, 600, 625, 650, 675, 700, 725, 750, 775, 800, 825, 850, 875, 900, 925, 950, 975, 1,000, 1,250, 1,500, 1,750, 2,000, 2,500, 5,000, 7,500, or about 10,000 or more crosslinker groups.

The crosslinker can have any suitable size, wherein for spherical particles the size is the diameter and for non-spherical particles the size of the largest dimension of the particle. For example, the crosslinker can have a size of about 0.1 nm to about 10,000 nm, about 1 nm to about 1,000 nm, about 1 nm to about 100 nm, or about 0.1 nm or less, or about 1 nm, 2, 3, 4, 5, 6, 7, 8, 9, 10, 12, 14, 16, 18, 20, 25, 30, 35, 40, 45, 50, 55, 60, 65, 70, 75, 80, 85, 90, 95, 100, 110, 120, 130, 140, 150, 160, 180, 200, 225, 250, 275, 300, 350, 400, 450, 500, 550, 600, 650, 700, 750, 800, 850, 900, 950, 1,000, 1,250, 1,500, 1,750, 2,000, 2,250, 2,500, 3,000, 4,000, 5,000, 6,000, 7,000, 8,000, 9,000, or about 10,000 nm or more. In some embodiments, the crosslinker can be a nanoparticle crosslinker (e.g., having a size of about 1 nm to about 100 nm). In some embodiments, the crosslinker can have a narrow size distribution, such as a standard deviation of about 0.1 nm to about 100 nm, or about 0.1 nm or less, or about 1 nm, 2, 3, 4, 5, 6, 7, 8, 9, 10, 12, 14, 16, 18, 20, 25, 30, 35, 40, 45, 50, 55, 60, 65, 70, 75, 80, 85, 90, 95, or about 100 or more.

The boronic acid or ester thereof can have the structure:

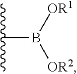

The variables R¹ and R² can be each independently selected from —H and substituted or unsubstituted (C₁-C₂₀)hydrocarbyl interrupted by 0, 1, 2, or 3 groups independently chosen from —O—, —S—, and substituted or unsubstituted —NH—, or R¹ and R² can together form a substituted or unsubstituted (C₁-C₂₀)hydrocarbylene interrupted by 0, 1, 2, or 3 groups independently chosen from —O—, —S—, and substituted or unsubstituted —NH—. The variables R and R² can each independently be selected from —H and (C₁-C₂₀)alkyl, or R¹ and R² can together form a substituted or unsubstituted (C₂-C₂₀)alkylene. The variables R¹ and R² can each independently be selected from —H and (C₁-C₅)alkyl, or R¹ and R² can together form a substituted or unsubstituted ethylene, such as a 1,2-diphenylethylene, or a 1,2-dimethylethylene. The variables R¹ and R² can each be selected such that the crosslinker begins crosslinking at a desired time under the subterranean conditions experienced by the composition, such as when particular conditions exist around the crosslinker (e.g., temperature, pH) and when a particular amount of time has passed.

The amine group can be directly bonded to the silica, or can be bonded via a linker L¹. Linker L¹ can be a substituted or unsubstituted (C₁-C₂₀)hydrocarbylene interrupted with 0, 1, 2, or 3 groups independently chosen from —O—, —S—, and substituted or unsubstituted —NH—. The variable L¹ can be (C₁-C₂₀)alkylene. The variable L¹ can be (C₁-C₅)alkylene. The variable L¹ can be propylene.

The boronic acid or ester thereof can be directly bonded to the amine group. In some embodiments, the silica bonded to the crosslinking group can have the structure:

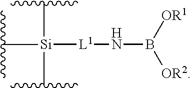

Herein, structures showing Si having three dangling bonds refer to a silicon atom in silica, wherein the silicon atom can be via oxygen atoms to other silicon atoms, wherein the silicon atoms form a network of silicon atoms interconnected via oxygen atoms (e.g., Si—O—Si).

In some embodiments, the boronic acid or ester thereof can be bonded to the amine group via a substituted or unsubstituted (C₁-C₂₀)hydrocarbylene linker, L², wherein the (C₁-C₂₀)hydrocarbylene can be interrupted with 0, 1, 2, or 3 groups independently chosen from —O—, —S—, and substituted or unsubstituted —NH—. The variable L² can be (C₆-C₁₀)aryl(C₁-C₁₀)alkyl. The variable L² can be phenyl(C₁-C₅)alkyl. The variable L² can be phenylmethyl. The silica bonded to the crosslinking group can have the structure:

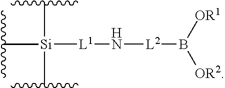

The boronic acid or ester thereof can be bonded to the amine group via a mono- or poly-aminoalkyl linker, L³. The variable L³ can be chosen from a —(NH—(C₁-C₅)alkyl)ₙ- group and a —(C₁-C₅)alkyl-(NH—(C₁-C₅)alkyl)ₙ- group, wherein the —NH— can be substituted or unsubstituted and n can be about 1 to about 10,000. The variable L³ can be chosen from a —(NH-ethylene)ₙ- group and a -ethylene-(ethylene)ₙ- group. The variable n can be about 1 to about 10,000, about 5 to about 500, about 10 to about 100, or about 1, 2, 3, 4, 5, 10, 15, 20, 25, 30, 35, 40, 45, 50, 55, 60, 65, 70, 75, 80, 85, 90, 95, 100, 110, 120, 130, 140, 150, 175, 200, 250, 300, 350, 400, 450, 500, 550, 600, 650, 700, 750, 800, 850, 900, 950, 1,000, 1,100, 1,250, 1,500, 1,750, 2,000, 2,500, 5,000, 7,500, or about 10,000 or more.

In some embodiments, the silica bonded to the crosslinking group has the structure:

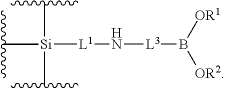

The silica bonded to the crosslinking group can have the structure:

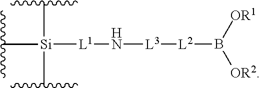

The variable L¹ can be chosen from a bond and a substituted or unsubstituted (C₁-C₂₀)hydrocarbylene interrupted with 0, 1, 2, or 3 groups independently chosen from —O—, —S—, and substituted or unsubstituted —NH—. The variable L² can be chosen from a bond and a substituted or unsubstituted (C₁-C₂₀)hydrocarbylene linker interrupted with 0, 1, 2, or 3 groups independently chosen from —O—, —S—, and substituted or unsubstituted —NH—. The variable L³ can be chosen from a bond, a —(NH—(C₁-C₅)alkyl)ₙ- group, and a —(C₁-C₅)alkyl-(NH—(C₁-C₅)alkyl)ₙ- group, wherein the —NH— can be substituted or unsubstituted and n can be about 1 to about 10,000. The variables R¹ and R² can be independently selected from —H and substituted or unsubstituted (C₁-C₂₀)hydrocarbyl interrupted by 0, 1, 2, or 3 groups independently chosen from —O—, —S—, and substituted or unsubstituted —NH—, or R¹ and R² can together form a substituted or unsubstituted (C₁-C₂₀)hydrocarbylene interrupted by 0, 1, 2, or 3 groups independently chosen from —O—, —S—, and substituted or unsubstituted —NH—.

The silica bonded to the crosslinking group can have the structure:

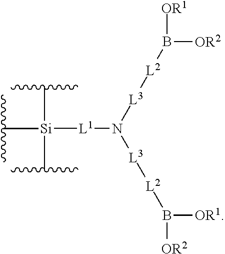

The variable L¹ can be chosen from a bond and a substituted or unsubstituted (C₁-C₂₀)hydrocarbylene interrupted with 0, 1, 2, or 3 groups independently chosen from —O—, —S—, and substituted or unsubstituted —NH—. At each occurrence, L² can be chosen from a bond and a substituted or unsubstituted (C₁-C₂₀)hydrocarbylene linker interrupted with 0, 1, 2, or 3 groups independently chosen from —O—, —S—, and substituted or unsubstituted —NH—. The variable L³ can be chosen from a bond, a —(NH—(C₁-C₅)alkyl)ₙ- group, and a —(C₁-C₅)alkyl-(NH—(C₁-C₅)alkyl)ₙ- group, wherein the —NH— can be substituted or unsubstituted and n can be about 1 to about 10,000. The variables R¹ and R² can be each independently selected from —H and substituted or unsubstituted (C₁-C₂₀)hydrocarbyl interrupted by 0, 1, 2, or 3 groups independently chosen from —O—, —S—, and substituted or unsubstituted —NH—, or R¹ and R² can together form a substituted or unsubstituted (C₁-C₂₀)hydrocarbylene interrupted by 0, 1, 2, or 3 groups independently chosen from —O—, —S—, and substituted or unsubstituted —NH—. The variable L³ can be independently selected at each occurrence.

The silica bonded to the crosslinking group can have the structure:

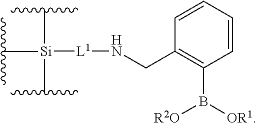

The silica bonded to the crosslinking group can have the structure:

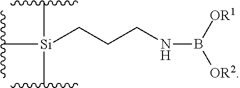

The silica bonded to the crosslinking group can have the structure:

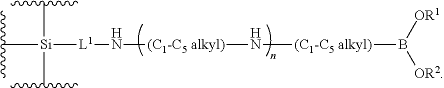

The silica bonded to the crosslinking group can have the structure:

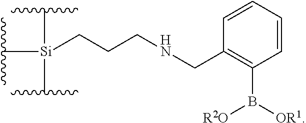

The silica bonded to the crosslinking group can have the structure:

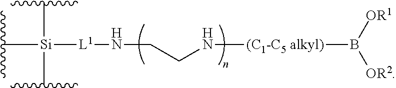

The silica bonded to the crosslinking group can have the structure:

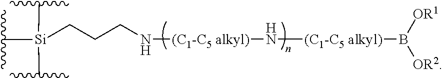

The silica bonded to the crosslinking group can have the structure:

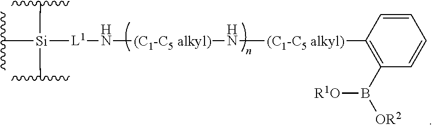

The silica bonded to the crosslinking group can have the structure:

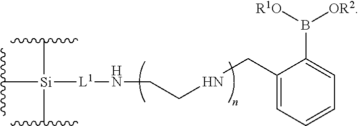

The silica bonded to the crosslinking group can have the structure:

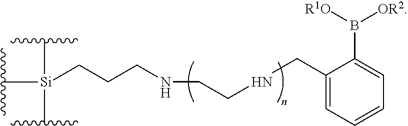

### Polysaccharide Viscosifier.

The composition can include a polysaccharide viscosifier. The composition can include one or more polysaccharide viscosifiers. The one or more polysaccharide viscosifiers can form any suitable proportion of the composition, such as about 0.01 wt % to about 40 wt % of the composition, about 1 wt % to about 20 wt %, or about 0.01 wt % or less, or about 0.1 wt %, 1, 2, 3, 4, 5, 6, 7, 8, 9, 10, 11, 12, 13, 14, 15, 16, 17, 18, 19, 20, 22, 24, 26, 28, 30, 32, 34, 36, 38, or about 40 wt % or more. The polysaccharide can be any suitable polysaccharide viscosifier, such that the polysaccharide viscosifier can be crosslinked by the silica crosslinker. In various embodiments, the polysaccharide viscosifier can be at least one of poly(acrylic acid) or (C₁-C₅)alkyl esters thereof, poly(methacrylic acid) or (C₁-C₅)alkyl esters thereof, poly(vinyl acetate), poly(vinyl alcohol), poly(ethylene glycol), poly(vinyl pyrrolidone), polyacrylamide, poly (hydroxyethyl methacrylate), alginate, chitosan, curdlan, dextran, derivatized dextran, emulsan, a galactoglucopolysaccharide, gellan, glucuronan, N-acetyl-glucosamine, N-acetyl-heparosan, hyaluronic acid, kefiran, lentinan, levan, mauran, pullulan, scleroglucan, schizophyllan, stewartan, succinoglycan, xanthan, diutan, welan, starch, derivatized starch, tamarind, tragacanth, guar gum, derivatized guar gum (e.g., hydroxypropyl guar, carboxy methyl guar, or carboxymethyl hydroxypropyl guar), gum ghatti, gum arabic, locust bean gum, cellulose, and derivatized cellulose (e.g., carboxymethyl cellulose, hydroxyethyl cellulose, carboxymethyl hydroxyethyl cellulose, hydroxypropyl cellulose, or methyl hydroxy ethyl cellulose). In some embodiments, the polysaccharide viscosifier ican be at least one of guar gum and a guar gum derivative. In some embodiments, the polysaccharide viscosifier can be at least one of guar gum, hydroxypropyl guar, carboxymethyl guar, or carboxymethyl hydroxypropyl guar.

### Other Components.

The composition including the viscosifier and the silica crosslinker, or a mixture including the composition, can include any suitable additional component in any suitable proportion, such that the viscosifier and the silica crosslinker, composition, or mixture including the same, can be used as described herein.

In some embodiments, the composition includes one or more secondary viscosifiers. The secondary viscosifier can be any suitable viscosifier. The secondary viscosifier can affect the viscosity of the composition or a solvent that contacts the composition at any suitable time and location. In some embodiments, the secondary viscosifier provides an increased viscosity at least one of before injection into the subterranean formation, at the time of injection into the subterranean formation, during travel through a tubular disposed in a borehole, once the composition reaches a particular subterranean location, or some period of time after the composition reaches a particular subterranean location. In some embodiments, the secondary viscosifier can be about 0.000,1 wt % to about 10 wt % of the composition or a mixture including the same, about 0.004 wt % to about 0.01 wt %, or about 0.000,1 wt % or less, 0.000,5 wt %, 0.001, 0.005, 0.01, 0.05, 0.1, 0.5, 1, 2, 3, 4, 5, 6, 7, 8, 9, or about 10 wt % or more of the composition or a mixture including the same.

The secondary viscosifier can include at least one of a substituted or unsubstituted polysaccharide, and a substituted or unsubstituted polyalkene (e.g., a polyethylene, wherein the ethylene unit is substituted or unsubstituted, derived from the corresponding substituted or unsubstituted ethene), wherein the polysaccharide or polyalkene is crosslinked or uncrosslinked. The secondary viscosifier can include a polymer including at least one repeating unit derived from a monomer selected from the group consisting of ethylene glycol, acrylamide, vinyl acetate, 2-acrylamidomethylpropane sulfonic acid or its salts, trimethylammoniumethyl acrylate halide, and trimethylammoniumethyl methacrylate halide. The secondary viscosifier can include a crosslinked gel or a crosslinkable gel. The secondary viscosifier can include at least one of a linear polysaccharide, and a poly((C₂-C₁₀)alkene), wherein the (C₂-C₁₀)alkene is substituted or unsubstituted. The secondary viscosifier can include at least one of poly(acrylic acid) or (C₁-C₅)alkyl esters thereof, poly(methacrylic acid) or (C₁-C₅)alkyl esters thereof, poly(vinyl acetate), poly(vinyl alcohol), poly(ethylene glycol), poly(vinyl pyrrolidone), polyacrylamide, poly (hydroxyethyl methacrylate), alginate, chitosan, curdlan, dextran, derivatized dextran, emulsan, a galactoglucopolysaccharide, gellan, glucuronan, N-acetyl-glucosamine, N-acetyl-heparosan, hyaluronic acid, kefiran, lentinan, levan, mauran, pullulan, scleroglucan, schizophyllan, stewartan, succinoglycan, xanthan, diutan, welan, starch, derivatized starch, tamarind, tragacanth, guar gum, derivatized guar gum (e.g., hydroxypropyl guar, carboxy methyl guar, or carboxymethyl hydroxypropyl guar), gum ghatti, gum arabic, locust bean gum, cellulose, and derivatized cellulose (e.g., carboxymethyl cellulose, hydroxyethyl cellulose, carboxymethyl hydroxyethyl cellulose, hydroxypropyl cellulose, or methyl hydroxy ethyl cellulose).

In some embodiments, the secondary viscosifier can include at least one of a poly(vinyl alcohol) homopolymer, poly(vinyl alcohol) copolymer, a crosslinked poly(vinyl alcohol) homopolymer, and a crosslinked poly(vinyl alcohol) copolymer. The secondary viscosifier can include a poly(vinyl alcohol) copolymer or a crosslinked poly(vinyl alcohol) copolymer including at least one of a graft, linear, branched, block, and random copolymer of vinyl alcohol and at least one of a substituted or unsubstituted (C₂-C₅₀)hydrocarbyl having at least one aliphatic unsaturated C—C bond therein, and a substituted or unsubstituted (C₂-C₅₀)alkene. The secondary viscosifier can include a poly(vinyl alcohol) copolymer or a crosslinked poly(vinyl alcohol) copolymer including at least one of a graft, linear, branched, block, and random copolymer of vinyl alcohol and at least one of vinyl phosphonic acid, vinylidene diphosphonic acid, substituted or unsubstituted 2-acrylamido-2-methylpropanesulfonic acid, a substituted or unsubstituted (C₁-C₂₀)alkenoic acid, propenoic acid, butenoic acid, pentenoic acid, hexenoic acid, octenoic acid, nonenoic acid, decenoic acid, acrylic acid, methacrylic acid, hydroxypropyl acrylic acid, acrylamide, fumaric acid, methacrylic acid, hydroxypropyl acrylic acid, vinyl phosphonic acid, vinylidene diphosphonic acid, itaconic acid, crotonic acid, mesoconic acid, citraconic acid, styrene sulfonic acid, allyl sulfonic acid, methallyl sulfonic acid, vinyl sulfonic acid, and a substituted or unsubstituted (C₁-C₂₀)alkyl ester thereof. The secondary viscosifier can include a poly(vinyl alcohol) copolymer or a crosslinked poly(vinyl alcohol) copolymer including at least one of a graft, linear, branched, block, and random copolymer of vinyl alcohol and at least one of vinyl acetate, vinyl propanoate, vinyl butanoate, vinyl pentanoate, vinyl hexanoate, vinyl 2-methyl butanoate, vinyl 3-ethylpentanoate, and vinyl 3-ethylhexanoate, maleic anhydride, a substituted or unsubstituted (C₁-C₂₀)alkenoic substituted or unsubstituted (C₁-C₂₀)alkanoic anhydride, a substituted or unsubstituted (C₁-C₂₀)alkenoic substituted or unsubstituted (C₁-C₂₀)alkenoic anhydride, propenoic acid anhydride, butenoic acid anhydride, pentenoic acid anhydride, hexenoic acid anhydride, octenoic acid anhydride, nonenoic acid anhydride, decenoic acid anhydride, acrylic acid anhydride, fumaric acid anhydride, methacrylic acid anhydride, hydroxypropyl acrylic acid anhydride, vinyl phosphonic acid anhydride, vinylidene diphosphonic acid anhydride, itaconic acid anhydride, crotonic acid anhydride, mesoconic acid anhydride, citraconic acid anhydride, styrene sulfonic acid anhydride, allyl sulfonic acid anhydride, methallyl sulfonic acid anhydride, vinyl sulfonic acid anhydride, and an N—(C₁-C₁₀)alkenyl nitrogen containing substituted or unsubstituted (C₁-C₁₀)heterocycle. The secondary viscosifier can include a poly(vinyl alcohol) copolymer or a crosslinked poly(vinyl alcohol) copolymer including at least one of a graft, linear, branched, block, and random copolymer that includes a poly(vinylalcohol/acrylamide) copolymer, a poly(vinylalcohol/2-acrylamido-2-methylpropanesulfonic acid) copolymer, a poly (acrylamide/2-acrylamido-2-methylpropanesulfonic acid) copolymer, or a poly(vinylalcohol/N-vinylpyrrolidone) copolymer. The secondary viscosifier can include a crosslinked poly(vinyl alcohol) homopolymer or copolymer including a crosslinker including at least one of chromium, aluminum, antimony, zirconium, titanium, calcium, boron, iron, silicon, copper, zinc, magnesium, and an ion thereof. The secondary viscosifier can include a crosslinked poly(vinyl alcohol) homopolymer or copolymer including a crosslinker including at least one of an aldehyde, an aldehyde-forming compound, a carboxylic acid or an ester thereof, a sulfonic acid or an ester thereof, a phosphonic acid or an ester thereof, an acid anhydride, and an epihalohydrin.

In various embodiments, the composition can include one or more secondary crosslinkers. The crosslinker can be any suitable crosslinker. In some examples, the secondary crosslinker can be incorporated in a crosslinked viscosifier (e.g., the viscosifier or the secondary viscosoifier), and in other examples, the secondary crosslinker can crosslink a crosslinkable material (e.g., downhole). The secondary crosslinker can include at least one of chromium, aluminum, antimony, zirconium, titanium, calcium, boron, iron, silicon, copper, zinc, magnesium, and an ion thereof. The secondary crosslinker can include at least one of boric acid, borax, a borate, a (C₁-C₃₀)hydrocarbylboronic acid, a (C₁-C₃₀)hydrocarbyl ester of a (C₁-C₃₀)hydrocarbylboronic acid, a (C₁-C₃₀)hydrocarbylboronic acid-modified polyacrylamide, ferric chloride, disodium octaborate tetrahydrate, sodium metaborate, sodium diborate, sodium tetraborate, disodium tetraborate, a pentaborate, ulexite, colemanite, magnesium oxide, zirconium lactate, zirconium triethanol amine, zirconium lactate triethanolamine, zirconium carbonate, zirconium acetylacetonate, zirconium malate, zirconium citrate, zirconium diisopropylamine lactate, zirconium glycolate, zirconium triethanol amine glycolate, zirconium lactate glycolate, titanium lactate, titanium malate, titanium citrate, titanium ammonium lactate, titanium triethanolamine, titanium acetylacetonate, aluminum lactate, and aluminum citrate. In some embodiments, the secondary crosslinker can be a (C₁-C₂₀)alkylenebiacrylamide (e.g., methylenebisacrylamide), a poly((C₁-C₂₀)alkenyl)-substituted mono- or poly-(C₁-C₂₀)alkyl ether (e.g., pentaerythritol allyl ether), and a poly(C₂-C₂₀)alkenylbenzene (e.g., divinylbenzene). In some embodiments, the secondary crosslinker can be at least one of alkyl diacrylate, ethylene glycol diacrylate, ethylene glycol dimethacrylate, polyethylene glycol diacrylate, polyethylene glycol dimethacrylate, ethoxylated bisphenol A diacrylate, ethoxylated bisphenol A dimethacrylate, ethoxylated trimethylol propane triacrylate, ethoxylated trimethylol propane trimethacrylate, ethoxylated glyceryl triacrylate, ethoxylated glyceryl trimethacrylate, ethoxylated pentaerythritol tetraacrylate, ethoxylated pentaerythritol tetramethacrylate, ethoxylated dipentaerythritol hexaacrylate, polyglyceryl monoethylene oxide polyacrylate, polyglyceryl polyethylene glycol polyacrylate, dipentaerythritol hexaacrylate, dipentaerythritol hexamethacrylate, neopentyl glycol diacrylate, neopentyl glycol dimethacrylate, pentaerythritol triacrylate, pentaerythritol trimethacrylate, trimethylol propane triacrylate, trimethylol propane trimethacrylate, tricyclodecane dimethanol diacrylate, tricyclodecane dimethanol dimethacrylate, 1,6-hexanediol diacrylate, and 1,6-hexanediol dimethacrylate. The secondary crosslinker can be about 0.000,01 wt % to about 5 wt % of the composition or a mixture including the same, about 0.001 wt % to about 0.01 wt %, or about 0.000,01 wt % or less, or about 0.000,05 wt %, 0.000,1, 0.000,5, 0.001, 0.005, 0.01, 0.05, 0.1, 0.5, 1, 2, 3, 4, or about 5 wt % or more.

In some embodiments, the composition can include one or more breakers. The breaker can be any suitable breaker, such that the surrounding fluid (e.g., a fracturing fluid) can be at least partially broken for more complete and more efficient recovery thereof, such as at the conclusion of the hydraulic fracturing treatment. In some embodiments, the breaker can be encapsulated or otherwise formulated to give a delayed-release or a time-release of the breaker, such that the surrounding liquid can remain viscous for a suitable amount of time prior to breaking. The breaker can be any suitable breaker; for example, the breaker can be a compound that includes a Na⁺, K⁺, Li⁺, Zn⁺, NH₄⁺, Fe²⁺, Fe³⁺, Cu¹⁺, Cu²⁺, Ca²⁺, Mg²⁺, Zn²⁺, and an Al³⁺ salt of a chloride, fluoride, bromide, phosphate, or sulfate ion. In some examples, the breaker can be an oxidative breaker or an enzymatic breaker. An oxidative breaker can be at least one of a Na⁺, K⁺, Li⁺, Zn⁺, NH₄⁺, Fe²⁺, Fe³⁺, Cu¹⁺, Cu²⁺, Ca²⁺, Mg²⁺, Zn²⁺, and an Al³⁺ salt of a persulfate, percarbonate, perborate, peroxide, perphosphosphate, permanganate, chlorite, or hyporchlorite ion. An enzymatic breaker can be at least one of an alpha or beta amylase, amyloglucosidase, oligoglucosidase, invertase, maltase, cellulase, hemi-cellulase, and mannanohydrolase. The breaker can be about 0.001 wt % to about 30 wt % of the composition or a mixture including the same, or about 0.01 wt % to about 5 wt %, or about 0.001 wt % or less, or about 0.005 wt %, 0.01, 0.05, 0.1, 0.5, 1, 2, 3, 4, 5, 6, 8, 10, 12, 14, 16, 18, 20, 22, 24, 26, 28, or about 30 wt % or more.

The composition, or a mixture including the composition, can include any suitable fluid. For example, the fluid can be at least one of crude oil, dipropylene glycol methyl ether, dipropylene glycol dimethyl ether, dipropylene glycol methyl ether, dipropylene glycol dimethyl ether, dimethyl formamide, diethylene glycol methyl ether, ethylene glycol butyl ether, diethylene glycol butyl ether, butylglycidyl ether, propylene carbonate, D-limonene, a C₂-C₄₀ fatty acid C₁-C₁₀ alkyl ester (e.g., a fatty acid methyl ester), tetrahydrofurfuryl methacrylate, tetrahydrofurfuryl acrylate, 2-butoxy ethanol, butyl acetate, butyl lactate, furfuryl acetate, dimethyl sulfoxide, dimethyl formamide, a petroleum distillation product of fraction (e.g., diesel, kerosene, napthas, and the like) mineral oil, a hydrocarbon oil, a hydrocarbon including an aromatic carbon-carbon bond (e.g., benzene, toluene), a hydrocarbon including an alpha olefin, xylenes, an ionic liquid, methyl ethyl ketone, an ester of oxalic, maleic or succinic acid, methanol, ethanol, propanol (iso- or normal-), butyl alcohol (iso-, tert-, or normal-), an aliphatic hydrocarbon (e.g., cyclohexanone, hexane), water, brine, produced water, flowback water, brackish water, and sea water. The fluid can form about 0.001 wt % to about 99.999 wt % of the composition, or a mixture including the same, or about 0.001 wt % or less, 0.01 wt %, 0.1, 1, 2, 3, 4, 5, 6, 8, 10, 15, 20, 25, 30, 35, 40, 45, 50, 55, 60, 65, 70, 75, 80, 85, 90, 95, 96, 97, 98, 99, 99.9, 99.99, or about 99.999 wt % or more.

The composition including the viscosifier and the silica crosslinker or a mixture including the same can include any suitable downhole fluid. The composition including the viscosifier and the silica crosslinker can be combined with any suitable downhole fluid before, during, or after the placement of the composition in the subterranean formation or the contacting of the composition and the subterranean material. In some examples, the composition including the viscosifier and the silica crosslinker is combined with a downhole fluid above the surface, and then the combined composition is placed in a subterranean formation or contacted with a subterranean material. In another example, the composition including the viscosifier and the silica crosslinker is injected into a subterranean formation to combine with a downhole fluid, and the combined composition is contacted with a subterranean material or is considered to be placed in the subterranean formation. The placement of the composition in the subterranean formation can include contacting the subterranean material and the mixture. Any suitable weight percent of the composition or of a mixture including the same that is placed in the subterranean formation or contacted with the subterranean material can be the downhole fluid, such as about 0.001 wt % to about 99.999 wt %, about 0.01 wt % to about 99.99 wt %, about 0.1 wt % to about 99.9 wt %, about 20 wt % to about 90 wt %, or about 0.001 wt % or less, or about 0.01 wt %, 0.1, 1, 2, 3, 4, 5, 10, 15, 20, 30, 40, 50, 60, 70, 80, 85, 90, 91, 92, 93, 94, 95, 96, 97, 98, 99, 99.9, 99.99 wt %, or about 99.999 wt % or more of the composition or mixture including the same.

In some embodiments, the composition, or a mixture including the same, can include any suitable amount of any suitable material used in a downhole fluid. For example, the composition or a mixture including the same can include water, saline, aqueous base, acid, oil, organic solvent, synthetic fluid oil phase, aqueous solution, alcohol or polyol, cellulose, starch, alkalinity control agents, acidity control agents, density control agents, density modifiers, emulsifiers, dispersants, polymeric stabilizers, crosslinking agents, polyacrylamide, a polymer or combination of polymers, antioxidants, heat stabilizers, foam control agents, solvents, diluents, plasticizer, filler or inorganic particle, pigment, dye, precipitating agent, rheology modifier, oil-wetting agents, set retarding additives, surfactants, gases, weight reducing additives, heavy-weight additives, lost circulation materials, filtration control additives, salts (e.g., any suitable salt, such as potassium salts such as potassium chloride, potassium bromide, potassium formate; calcium salts such as calcium chloride, calcium bromide, calcium formate; cesium salts such as cesium chloride, cesium bromide, cesium formate, or a combination thereof), fibers, thixotropic additives, breakers, crosslinkers, rheology modifiers, curing accelerators, curing retarders, pH modifiers, chelating agents, scale inhibitors, enzymes, resins, water control materials, oxidizers, markers, Portland cement, pozzolana cement, gypsum cement, high alumina content cement, slag cement, silica cement, fly ash, metakaolin, shale, zeolite, a crystalline silica compound, amorphous silica, hydratable clays, microspheres, lime, a chelator, a hydrogen sulfide scavenger, a breaker, a breaker activator, or a combination thereof. In various embodiments, the composition or a mixture including the same can include one or more additive components such as: COLDTROL®, ATC®, OMC 2™, and OMC 42™ thinner additives; RHEMOD™ viscosifier and suspension agent; TEMPERUS™ and VIS-PLUS® additives for providing temporary increased viscosity; TAU-MOD™ viscosifying/suspension agent; ADAPTA®, DURATONE® HT, THERMO TONE™, BDF™-366, and BDF™-454 filtration control agents; LIQUITONE™ polymeric filtration agent and viscosifier; FACTANT™ emulsion stabilizer; LE SUPERMUL™, EZ MUL® NT, and FORTI-MUL® emulsifiers; DRIL TREAT® oil wetting agent for heavy fluids; BARACARB® bridging agent; BAROID® weighting agent; BAROLIFT® hole sweeping agent; SWEEP-WATE® sweep weighting agent; BDF-508 rheology modifier; and GELTONE® II organophilic clay. In various embodiments, the composition or a mixture including the same can include one or more additive components such as: X-TEND® II, PAC™-R, PAC™-L, LIQUI-VIS® EP, BRINEDRIL-VIS™, BARAZAN®, N-VIS®, and AQUAGEL® viscosifiers; THERMA-CHEK®, N-DRIL™ N-DRIL™ HT PLUS, IMPERMEX®, FILTERCHEK™, DEXTRID®, CARBONOX®, and BARANEX® filtration control agents; PERFORMATROL®, GEM™ EZ-MUD®, CLAY GRABBER®, CLAYSEAL®, CRYSTAL-DRIL®, and CLAY SYNC™ II shale stabilizers; NXS-LUBE™, EP MUDLUBE®, and DRIL-N-SLIDE™ lubricants; QUIK-THIN®, IRON-THIN™, and ENVIRO-THIN™ thinners; SOURSCAV™ scavenger; BARACOR® corrosion inhibitor; and WALL-NUT®, SWEEP-WATE®, STOPPIT™ PLUG-GIT®, BARACARB®, DUO-SQUEEZE®, BAROFIBRE™, STEELSEAL®, and HYDRO-PLUG® lost circulation management materials. Any suitable proportion of the composition or mixture including the composition can include any optional component listed in this paragraph, such as about 0.001 wt % to about 99.999 wt %, about 0.01 wt % to about 99.99 wt %, about 0.1 wt % to about 99.9 wt %, about 20 to about 90 wt %, or about 0.001 wt % or less, or about 0.01 wt %, 0.1, 1, 2, 3, 4, 5, 10, 15, 20, 30, 40, 50, 60, 70, 80, 85, 90, 91, 92, 93, 94, 95, 96, 97, 98, 99, 99.9, 99.99 wt %, or about 99.999 wt % or more of the composition or mixture.

A drilling fluid, also known as a drilling mud or simply “mud,” is a specially designed fluid that is circulated through a wellbore as the wellbore is being drilled to facilitate the drilling operation. The drilling fluid can be water-based. The drilling fluid can carry cuttings up from beneath and around the bit, transport them up the annulus, and allow their separation. Also, a drilling fluid can cool and lubricate the drill bit as well as reduce friction between the drill string and the sides of the hole. The drilling fluid aids in support of the drill pipe and drill bit, and provides a hydrostatic head to maintain the integrity of the wellbore walls and prevent well blowouts. Specific drilling fluid systems can be selected to optimize a drilling operation in accordance with the characteristics of a particular geological formation. The drilling fluid can be formulated to prevent unwanted influxes of formation fluids from permeable rocks and also to form a thin, low permeability filter cake that temporarily seals pores, other openings, and formations penetrated by the bit. In water-based drilling fluids, solid particles are suspended in a water or brine solution containing other components. Oils or other non-aqueous liquids can be emulsified in the water or brine or at least partially solubilized (for less hydrophobic non-aqueous liquids), but water is the continuous phase. A drilling fluid can be present in the composition or a mixture including the same in any suitable amount, such as about 1 wt % or less, about 2 wt %, 3, 4, 5, 10, 15, 20, 30, 40, 50, 60, 70, 80, 85, 90, 95, 96, 97, 98, 99, 99.9, 99.99, or about 99.999 wt % or more.

A water-based drilling fluid in embodiments of the present invention can be any suitable water-based drilling fluid. In various embodiments, the drilling fluid can include at least one of water (fresh or brine), a salt (e.g., calcium chloride, sodium chloride, potassium chloride, magnesium chloride, calcium bromide, sodium bromide, potassium bromide, calcium nitrate, sodium formate, potassium formate, cesium formate), aqueous base (e.g., sodium hydroxide or potassium hydroxide), alcohol or polyol, cellulose, starches, alkalinity control agents, density control agents such as a density modifier (e.g., barium sulfate), surfactants (e.g., betaines, alkali metal alkylene acetates, sultaines, ether carboxylates), emulsifiers, dispersants, polymeric stabilizers, crosslinking agents, polyacrylamides, polymers or combinations of polymers, antioxidants, heat stabilizers, foam control agents, solvents, diluents, plasticizers, filler or inorganic particles (e.g., silica), pigments, dyes, precipitating agents (e.g., silicates or aluminum complexes), and rheology modifiers such as thickeners or viscosifiers (e.g., xanthan gum). Any ingredient listed in this paragraph can be either present or not present in the mixture.

A pill is a relatively small quantity (e.g., less than about 500 bbl, or less than about 200 bbl) of drilling fluid used to accomplish a specific task that the regular drilling fluid cannot perform. For example, a pill can be a high-viscosity pill to, for example, help lift cuttings out of a vertical wellbore. In another example, a pill can be a freshwater pill to, for example, dissolve a salt formation. Another example is a pipe-freeing pill to, for example, destroy filter cake and relieve differential sticking forces. In another example, a pill is a lost circulation material pill to, for example, plug a thief zone. A pill can include any component described herein as a component of a drilling fluid.

A cement fluid can include an aqueous mixture of at least one of cement and cement kiln dust. The composition including the viscosifier and the silica crosslinker can form a useful combination with cement or cement kiln dust. The cement kiln dust can be any suitable cement kiln dust. Cement kiln dust can be formed during the manufacture of cement and can be partially calcined kiln feed that is removed from the gas stream and collected in a dust collector during a manufacturing process. Cement kiln dust can be advantageously utilized in a cost-effective manner since kiln dust is often regarded as a low value waste product of the cement industry. Some embodiments of the cement fluid can include cement kiln dust but no cement, cement kiln dust and cement, or cement but no cement kiln dust. The cement can be any suitable cement. The cement can be a hydraulic cement. A variety of cements can be utilized in accordance with embodiments of the present invention; for example, those including calcium, aluminum, silicon, oxygen, iron, or sulfur, which can set and harden by reaction with water. Suitable cements can include Portland cements, pozzolana cements, gypsum cements, high alumina content cements, slag cements, silica cements, and combinations thereof. In some embodiments, the Portland cements that are suitable for use in embodiments of the present invention are classified as Classes A, C, H, and G cements according to the American Petroleum Institute, API Specification for Materials and Testing for Well Cements, API Specification 10, Fifth Ed., Jul. 1, 1990. A cement can be generally included in the cementing fluid in an amount sufficient to provide the desired compressive strength, density, or cost. In some embodiments, the hydraulic cement can be present in the cementing fluid in an amount in the range of from 0 wt % to about 100 wt %, about 0 wt % to about 95 wt %, about 20 wt % to about 95 wt %, or about 50 wt % to about 90 wt %. A cement kiln dust can be present in an amount of at least about 0.01 wt %, or about 5 wt % to about 80 wt %, or about 10 wt % to about 50 wt %.

Optionally, other additives can be added to a cement or kiln dust-containing composition of embodiments of the present invention as deemed appropriate by one skilled in the art, with the benefit of this disclosure. Any optional ingredient listed in this paragraph can be either present or not present in the composition. For example, the composition can include fly ash, metakaolin, shale, zeolite, set retarding additive, surfactant, a gas, accelerators, weight reducing additives, heavy-weight additives, lost circulation materials, filtration control additives, dispersants, and combinations thereof. In some examples, additives can include crystalline silica compounds, amorphous silica, salts, fibers, hydratable clays, microspheres, pozzolan lime, thixotropic additives, combinations thereof, and the like.

In various embodiments, the composition or mixture can include a proppant, a resin-coated proppant, an encapsulated resin, or a combination thereof. A proppant is a material that keeps an induced hydraulic fracture at least partially open during or after a fracturing treatment. Proppants can be transported into the subterranean formation (e.g., downhole) to the fracture using fluid, such as fracturing fluid or another fluid. A higher-viscosity fluid can more effectively transport proppants to a desired location in a fracture, especially larger proppants, by more effectively keeping proppants in a suspended state within the fluid. Examples of proppants can include sand, gravel, glass beads, polymer beads, ground products from shells and seeds such as walnut hulls, and manmade materials such as ceramic proppant, bauxite, tetrafluoroethylene materials (e.g., TEFLON™ polytetrafluoroethylene), fruit pit materials, processed wood, composite particulates prepared from a binder and fine grade particulates such as silica, alumina, fumed silica, carbon black, graphite, mica, titanium dioxide, meta-silicate, calcium silicate, kaolin, talc, zirconia, boron, fly ash, hollow glass microspheres, and solid glass, or mixtures thereof. In some embodiments, the proppant can have an average particle size, wherein particle size is the largest dimension of a particle, of about 0.001 mm to about 3 mm, about 0.15 mm to about 2.5 mm, about 0.25 mm to about 0.43 mm, about 0.43 mm to about 0.85 mm, about 0.85 mm to about 1.18 mm, about 1.18 mm to about 1.70 mm, or about 1.70 to about 2.36 mm. In some embodiments, the proppant can have a distribution of particle sizes clustering around multiple averages, such as one, two, three, or four different average particle sizes. The composition or mixture can include any suitable amount of proppant, such as about 0.01 wt % to about 99.99 wt %, about 0.1 wt % to about 80 wt %, about 10 wt % to about 60 wt %, or about 0.01 wt % or less, or about 0.1 wt %, 1, 2, 3, 4, 5, 10, 15, 20, 30, 40, 50, 60, 70, 80, 85, 90, 91, 92, 93, 94, 95, 96, 97, 98, 99, about 99.9 wt %, or about 99.99 wt % or more.

The composition can include a payload material. The payload can be deposited in any suitable subterranean location. The method can include using the composition to deposit a payload material into a subterranean fracture. In some embodiments, the silica is a hollow shell in the crosslinker, and the payload material is inside the hollow shell. The payload material can be release via breaking or breaching of the hollow shell. In other embodiments, the silica includes pores, and the payload material is inside the pores. The payload material can be any suitable payload material, such as any optional component of the composition described herein, such as a curable material, an encapsulated resin, a resin, a Portland cement, a pozzolana cement, a gypsum cement, a high alumina content cement, a slag cement, a silica cement, a cementitous kiln dust, fly ash, metakaolin, shale, zeolite, a set retarding additive, a corrosion inhibitor, a surfactant, a gas, an accelerator, a weight reducing additive, a heavy-weight additive, a lost circulation material, a filtration control additive, a dispersant, a crystalline silica compound, an amorphous silica, a salt, a fiber, a hydratable clay, a microsphere, pozzolan lime, a thixotropic additive, water, an aqueous base, an aqueous acid, an alcohol or polyol, a cellulose, a starch, an alkalinity control agent, an acidity control agent, a density control agent, a density modifier, an emulsifier, a polymeric stabilizer, a crosslinking agent, a polyacrylamide, a polymer or combination of polymers, an antioxidant, a heat stabilizer, a foam control agent, a solvent, a diluent, a plasticizer, a filler or inorganic particle, a pigment, a dye, a precipitating agent, a rheology modifier, or a combination thereof.

### Drilling Assembly.

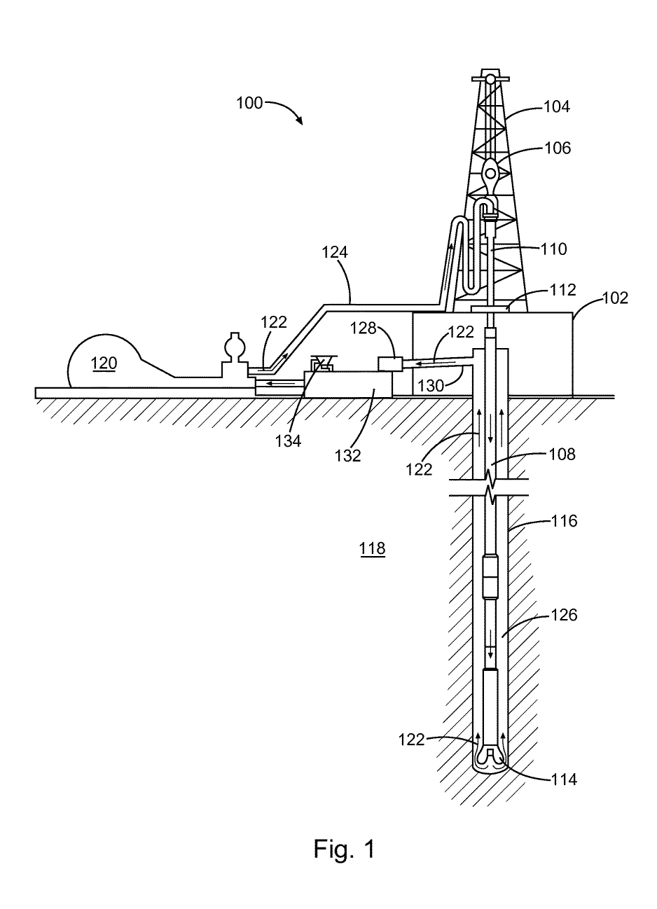

In various embodiments, the composition including the viscosifier and the silica crosslinker disclosed herein can directly or indirectly affect one or more components or pieces of equipment associated with the preparation, delivery, recapture, recycling, reuse, and/or disposal of the disclosed composition. For example, and with reference to FIG. 1, the disclosed composition including the viscosifier and the silica crosslinker can directly or indirectly affect one or more components or pieces of equipment associated with an exemplary wellbore drilling assembly 100, according to one or more embodiments. It should be noted that while FIG. 1 generally depicts a land-based drilling assembly, those skilled in the art will readily recognize that the principles described herein are equally applicable to subsea drilling operations that employ floating or sea-based platforms and rigs, without departing from the scope of the disclosure.

As illustrated, the drilling assembly 100 can include a drilling platform 102 that supports a derrick 104 having a traveling block 106 for raising and lowering a drill string 108. The drill string 108 can include drill pipe and coiled tubing, as generally known to those skilled in the art. A kelly 110 supports the drill string 108 as it is lowered through a rotary table 112. A drill bit 114 is attached to the distal end of the drill string 108 and is driven either by a downhole motor and/or via rotation of the drill string 108 from the well surface. As the bit 114 rotates, it creates a wellbore 116 that penetrates various subterranean formations 118.

A pump 120 (e.g., a mud pump) circulates drilling fluid 122 through a feed pipe 124 and to the kelly 110, which conveys the drilling fluid 122 downhole through the interior of the drill string 108 and through one or more orifices in the drill bit 114. The drilling fluid 122 is then circulated back to the surface via an annulus 126 defined between the drill string 108 and the walls of the wellbore 116. At the surface, the recirculated or spent drilling fluid 122 exits the annulus 126 and can be conveyed to one or more fluid processing unit(s) 128 via an interconnecting flow line 130. After passing through the fluid processing unit(s) 128, a “cleaned” drilling fluid 122 is deposited into a nearby retention pit 132 (e.g., a mud pit). While illustrated as being arranged at the outlet of the wellbore 116 via the annulus 126, those skilled in the art will readily appreciate that the fluid processing unit(s) 128 can be arranged at any other location in the drilling assembly 100 to facilitate its proper function, without departing from the scope of the disclosure.

The composition including the viscosifier and the silica crosslinker can be added to the drilling fluid 122 via a mixing hopper 134 communicably coupled to or otherwise in fluid communication with the retention pit 132. The mixing hopper 134 can include mixers and related mixing equipment known to those skilled in the art. In other embodiments, however, the composition including the viscosifier and the silica crosslinker can be added to the drilling fluid 122 at any other location in the drilling assembly 100. In at least one embodiment, for example, there could be more than one retention pit 132, such as multiple retention pits 132 in series. Moreover, the retention pit 132 can be representative of one or more fluid storage facilities and/or units where the composition including the viscosifier and the silica crosslinker can be stored, reconditioned, and/or regulated until added to the drilling fluid 122.

As mentioned above, the composition including the viscosifier and the silica crosslinker can directly or indirectly affect the components and equipment of the drilling assembly 100. For example, the composition including the viscosifier and the silica crosslinker can directly or indirectly affect the fluid processing unit(s) 128, which can include one or more of a shaker (e.g., shale shaker), a centrifuge, a hydrocyclone, a separator (including magnetic and electrical separators), a desilter, a desander, a separator, a filter (e.g., diatomaceous earth filters), a heat exchanger, or any fluid reclamation equipment. The fluid processing unit(s) 128 can further include one or more sensors, gauges, pumps, compressors, and the like used to store, monitor, regulate, and/or recondition the composition including the viscosifier and the silica crosslinker.

The composition including the viscosifier and the silica crosslinker can directly or indirectly affect the pump 120, which representatively includes any conduits, pipelines, trucks, tubulars, and/or pipes used to fluidically convey the composition including the viscosifier and the silica crosslinker to the subterranean formation, any pumps, compressors, or motors (e.g., topside or downhole) used to drive the composition into motion, any valves or related joints used to regulate the pressure or flow rate of the composition, and any sensors (e.g., pressure, temperature, flow rate, and the like), gauges, and/or combinations thereof, and the like. The composition including the viscosifier and the silica crosslinker can also directly or indirectly affect the mixing hopper 134 and the retention pit 132 and their assorted variations.

The composition including the viscosifier and the silica crosslinker can also directly or indirectly affect the various downhole or subterranean equipment and tools that can come into contact with the composition including the viscosifier and the silica crosslinker such as the drill string 108, any floats, drill collars, mud motors, downhole motors, and/or pumps associated with the drill string 108, and any measurement while drilling (MWD)/logging while drilling (LWD) tools and related telemetry equipment, sensors, or distributed sensors associated with the drill string 108. The composition including the viscosifier and the silica crosslinker can also directly or indirectly affect any downhole heat exchangers, valves and corresponding actuation devices, tool seals, packers and other wellbore isolation devices or components, and the like associated with the wellbore 116. The composition including the viscosifier and the silica crosslinker can also directly or indirectly affect the drill bit 114, which can include roller cone bits, polycrystalline diamond compact (PDC) bits, natural diamond bits, hole openers, reamers, coring bits, and the like.

While not specifically illustrated herein, the composition including the viscosifier and the silica crosslinker can also directly or indirectly affect any transport or delivery equipment used to convey the composition including the viscosifier and the silica crosslinker to the drilling assembly 100 such as, for example, any transport vessels, conduits, pipelines, trucks, tubulars, and/or pipes used to fluidically move the composition including the viscosifier and the silica crosslinker from one location to another, any pumps, compressors, or motors used to drive the composition into motion, any valves or related joints used to regulate the pressure or flow rate of the composition, and any sensors (e.g., pressure and temperature), gauges, and/or combinations thereof, and the like.

### System or Apparatus.

In various embodiments, the present invention provides a system. The system can be any suitable system that can use or that can be generated by use of an embodiment of the composition described herein in a subterranean formation, or that can perform or be generated by performance of a method for using the composition described herein. The system can include a composition including the viscosifier and the silica crosslinker, or including a crosslinked reaction product thereof. The system can also include a subterranean formation including the composition therein. In some embodiments, the composition in the system can also include a downhole fluid, or the system can include a mixture of the composition and downhole fluid. In some embodiments, the system can include a tubular, and a pump configured to pump the composition into the subterranean formation through the tubular.

Various embodiments provide systems and apparatus configured for delivering the composition described herein to a subterranean location and for using the composition therein, such as for a drilling operation, or a fracturing operation (e.g., pre-pad, pad, slurry, or finishing stages). In various embodiments, the system or apparatus can include a pump fluidly coupled to a tubular (e.g., any suitable type of oilfield pipe, such as pipeline, drill pipe, production tubing, and the like), with the tubular containing a composition including the viscosifier and the silica crosslinker described herein, or including a crosslinked reaction product thereof.

In some embodiments, the system can include a drill string disposed in a wellbore, with the drill string including a drill bit at a downhole end of the drill string. The system can also include an annulus between the drill string and the wellbore. The system can also include a pump configured to circulate the composition through the drill string, through the drill bit, and back above-surface through the annulus. In some embodiments, the system can include a fluid processing unit configured to process the composition exiting the annulus to generate a cleaned drilling fluid for recirculation through the wellbore.

The pump can be a high pressure pump in some embodiments. As used herein, the term “high pressure pump” will refer to a pump that is capable of delivering a fluid to a subterranean formation (e.g., downhole) at a pressure of about 1000 psi or greater. A high pressure pump can be used when it is desired to introduce the composition to a subterranean formation at or above a fracture gradient of the subterranean formation, but it can also be used in cases where fracturing is not desired. In some embodiments, the high pressure pump can be capable of fluidly conveying particulate matter, such as proppant particulates, into the subterranean formation. Suitable high pressure pumps will be known to one having ordinary skill in the art and can include floating piston pumps and positive displacement pumps.

In other embodiments, the pump can be a low pressure pump. As used herein, the term “low pressure pump” will refer to a pump that operates at a pressure of about 1000 psi or less. In some embodiments, a low pressure pump can be fluidly coupled to a high pressure pump that is fluidly coupled to the tubular. That is, in such embodiments, the low pressure pump can be configured to convey the composition to the high pressure pump. In such embodiments, the low pressure pump can “step up” the pressure of the composition before it reaches the high pressure pump.

In some embodiments, the systems or apparatuses described herein can further include a mixing tank that is upstream of the pump and in which the composition is formulated. In various embodiments, the pump (e.g., a low pressure pump, a high pressure pump, or a combination thereof) can convey the composition from the mixing tank or other source of the composition to the tubular. In other embodiments, however, the composition can be formulated offsite and transported to a worksite, in which case the composition can be introduced to the tubular via the pump directly from its shipping container (e.g., a truck, a railcar, a barge, or the like) or from a transport pipeline. In either case, the composition can be drawn into the pump, elevated to an appropriate pressure, and then introduced into the tubular for delivery to the subterranean formation.

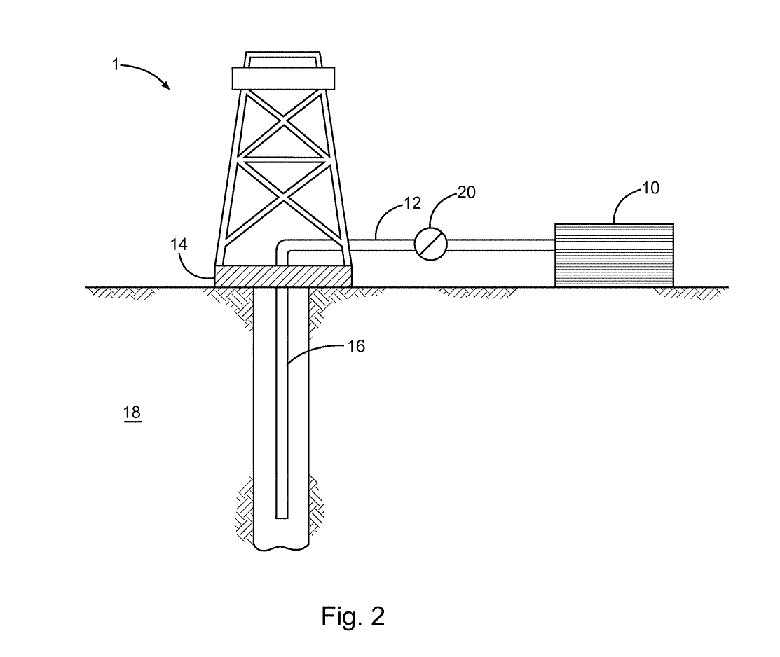

FIG. 2 shows an illustrative schematic of systems and apparatuses that can deliver embodiments of the compositions of the present invention to a subterranean location, according to one or more embodiments. It should be noted that while FIG. 2 generally depicts a land-based system or apparatus, it is to be recognized that like systems and apparatuses can be operated in subsea locations as well. Embodiments of the present invention can have a different scale than that depicted in FIG. 2. As depicted in FIG. 2, system or apparatus 1 can include mixing tank 10, in which an embodiment of the composition can be formulated. The composition can be conveyed via line 12 to wellhead 14, where the composition enters tubular 16, with tubular 16 extending from wellhead 14 into subterranean formation 18. Upon being ejected from tubular 16, the composition can subsequently penetrate into subterranean formation 18. Pump 20 can be configured to raise the pressure of the composition to a desired degree before its introduction into tubular 16. It is to be recognized that system or apparatus 1 is merely exemplary in nature and various additional components can be present that have not necessarily been depicted in FIG. 2 in the interest of clarity. In some examples, additional components that can be present include supply hoppers, valves, condensers, adapters, joints, gauges, sensors, compressors, pressure controllers, pressure sensors, flow rate controllers, flow rate sensors, temperature sensors, and the like.

Although not depicted in FIG. 2, at least part of the composition can, in some embodiments, flow back to wellhead 14 and exit subterranean formation 18. The composition that flows back can be substantially diminished in the concentration of the silica crosslinker or viscosifier therein. In some embodiments, the composition that has flowed back to wellhead 14 can subsequently be recovered, and in some examples reformulated, and recirculated to subterranean formation 18.

It is also to be recognized that the disclosed composition can also directly or indirectly affect the various downhole or subterranean equipment and tools that can come into contact with the composition during operation. Such equipment and tools can include wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, and the like), logging tools and related telemetry equipment, actuators (e.g., electromechanical devices, hydromechanical devices, and the like), sliding sleeves, production sleeves, plugs, screens, filters, flow control devices (e.g., inflow control devices, autonomous inflow control devices, outflow control devices, and the like), couplings (e.g., electro-hydraulic wet connect, dry connect, inductive coupler, and the like), control lines (e.g., electrical, fiber optic, hydraulic, and the like), surveillance lines, drill bits and reamers, sensors or distributed sensors, downhole heat exchangers, valves and corresponding actuation devices, tool seals, packers, cement plugs, bridge plugs, and other wellbore isolation devices or components, and the like. Any of these components can be included in the systems and apparatuses generally described above and depicted in FIG. 2.

### Composition for Treatment of a Subterranean Formation.

Various embodiments provide a composition for treatment of a subterranean formation. The composition can be any suitable composition that can be used to perform an embodiment of the method for treatment of a subterranean formation described herein.

For example, the composition can include a polysaccharide viscosifier and a crosslinker including a silica bonded to at least one crosslinking group that includes at least one amine group including at least one of a boronic acid and an ester thereof. Various embodiments provide a composition including a reaction product of the polysaccharide viscosifier and the crosslinker.

In some embodiments, the composition further includes a downhole fluid. The downhole fluid can be any suitable downhole fluid. In some embodiments, the downhole fluid is a composition for fracturing of a subterranean formation or subterranean material, or a fracturing fluid. In some embodiments, the downhole fluid is a drilling fluid.

In some embodiments, the composition can include a polysaccharide viscosifier and a nanoparticle crosslinker including a silica bonded to at least one crosslinking group. The silica bonded to the crosslinking group can have the structure

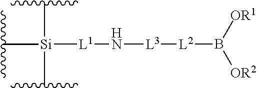

The silicon atom shown is part of a silica matrix that includes a network of silicon atoms linked to one another via oxygen atoms (e.g., Si—O—Si), with termination of the network occurring in any suitable way, such as via Si—OH groups or Si—O-substituent groups. The variable L¹ can be chosen from a bond and a substituted or unsubstituted (C₁-C₂₀)hydrocarbylene interrupted with 0, 1, 2, or 3 groups independently chosen from —O—, —S—, and substituted or unsubstituted —NH—. The variable L² can be chosen from a bond and a substituted or unsubstituted (C₁-C₂₀)hydrocarbylene linker interrupted with 0, 1, 2, or 3 groups independently chosen from —O—, —S—, and substituted or unsubstituted —NH—. The variable L³ can be chosen from a bond, a —(NH—(C₁-C₅)alkyl)ₙ- group, and a —(C₁-C₅)alkyl-(NH—(C₁-C₅)alkyl)ₙ- group, wherein n is about 1 to about 10,000. The variables R¹ and R² can be each independently selected from —H and substituted or unsubstituted (C₁-C₂₀)hydrocarbyl interrupted by 0, 1, 2, or 3 groups independently chosen from —O—, —S—, and substituted or unsubstituted —NH—, or wherein R¹ and R² together form a substituted or unsubstituted (C₁-C₂₀)hydrocarbylene interrupted by 0, 1, 2, or 3 groups independently chosen from —O—, —S—, and substituted or unsubstituted —NH—.

### Method for Preparing a Composition for Treatment of a Subterranean Formation.

In various embodiments, the present invention provides a method for preparing a composition for treatment of a subterranean formation. The method can be any suitable method that produces a composition described herein. For example, the method can include forming a composition including a polysaccharide viscosifier and a crosslinker including a silica bonded to at least one crosslinking group that includes at least one amine group including at least one of a boronic acid and an ester thereof.

In various examples, the method can include forming a silica including a tri(C1-C5)alkoxysilyl(C₁-C₂₀)hydrocarbylamine, such that the silica formed incorporates Si—(C₁-C₂₀)hydrocarbylamine groups, wherein the (C₁-C₂₀)hydrocarbylene is substituted or unsubstituted and interrupted with 0, 1, 2, or 3 groups independently chosen from —O—, —S—, and substituted or unsubstituted —NH—. The method can include allowing the amine-functionalized silica to react with a suitable material to install boronic acid or boronic acid ester groups thereon, such as an aldehyde-functionalized boronic acid or boronic acid ester. In some embodiments, the boronic acid or boronic acid ester can be installed by reacting the amine-functionalized silica with a compound having the structure:

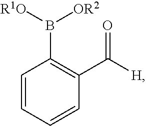

to form an Si—(C₁-C₂₀)hydrocarbylaminomethylphenylboronic acid or ester thereof. In other embodiments, the aldehyde-functionalized boronic acid or boronic acid ester can any suitable substitution pattern around the phenyl ring (e.g., ortho, meta, para), or around another organic group. In another embodiment, the amine-functionalized silica can be allowed to react with a (C₁-C₅)alkyl-B(OR¹)OR² to form an Si—(C₁-C₂₀)hydrocarbylaminoboronic acid or ester thereof.

In various embodiments, the aldehyde can be first reacted with a mono- or poly-aminoalkane, such as an H—(NH—(C₁-C₅)alkyl)ₙ-NH₂ or H₂N—(C₁-C₅)alkyl-NH₂, and the resulting mono- or poly-aminoalkane-substituted phenylboronic acid or ester thereof can be reacted with suitable reagents to form a bond between the amino substituents of the mono- or poly-aminoalkane-substituted phenylboronic acid or ester thereof and the amino groups of the silica, via a linker such as substituted or unsubstituted (C₁-C₅)alkyl. In another embodiment, the amine-functionalized silica is reacted with aziridine to generate a polyethylamino group of suitable length, and the resulting polyethylamino-functionalized silica is reacted with the aldehyde-functionalized boronic acid or ester thereof.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### Additional Embodiments

The following exemplary embodiments are provided, the numbering of which is not to be construed as designating levels of importance:

Embodiment 1 provides a method of treating a subterranean formation, the method comprising:

placing in a subterranean formation a composition comprising
a polysaccharide viscosifier; and
a crosslinker comprising a silica bonded to at least one crosslinking group that comprises at least one amine group comprising at least one of a boronic acid and an ester thereof.

Embodiment 2 provides the method of Embodiment 1, wherein the method further comprises at least one of fracturing the subterranean formation and performing a gravel pack operation in the subterranean formation.

Embodiment 3 provides the method of any one of Embodiments 1-2, wherein the method further comprises drilling the subterranean formation.

Embodiment 4 provides the method of any one of Embodiments 1-3, wherein the method further comprises crosslinking the polysaccharide viscosifier with the crosslinker.

Embodiment 5 provides the method of Embodiment 4, wherein the crosslinking occurs at least partially above-surface.

Embodiment 6 provides the method of any one of Embodiments 4-5, wherein the crosslinking occurs at least partially in the subterranean formation.

Embodiment 7 provides the method of any one of Embodiments 1-6, wherein the crosslinker is about 0.000,1 wt % to about 30 wt % of the composition.

Embodiment 8 provides the method of any one of Embodiments 1-7, wherein the crosslinker is about 0.001 wt % to about 10 wt % of the composition.

Embodiment 9 provides the method of any one of Embodiments 1-8, wherein the crosslinker has a size of about 0.1 nm to about 10,000 nm.

Embodiment 10 provides the method of any one of Embodiments 1-9, wherein the crosslinker has a size of about 1 nm to about 1,000 nm.

Embodiment 11 provides the method of any one of Embodiments 1-10, wherein the crosslinker is a nanoparticle.

Embodiment 12 provides the method of any one of Embodiments 1-11, wherein the silica is a silica core in the crosslinker.

Embodiment 13 provides the method of any one of Embodiments 1-12, wherein the silica is a hollow shell in the crosslinker.

Embodiment 14 provides the method of any one of Embodiments 1-13, wherein the silica comprises at least one of fused quartz, crystalline silica, fumed silica, silica gel, and an aerogel.

Embodiment 15 provides the method of any one of Embodiments 1-14, wherein the silica comprises iron oxide.

Embodiment 16 provides the method of any one of Embodiments 1-15, wherein the silica comprises an iron oxide core.

Embodiment 17 provides the method of any one of Embodiments 1-16, wherein the crosslinker comprises about 1 to about 100,000 of the crosslinker groups.

Embodiment 18 provides the method of any one of Embodiments 1-17, wherein the crosslinker comprises about 25 to about 1,000 crosslinker groups.

Embodiment 19 provides the method of any one of Embodiments 1-18, wherein the boronic acid or ester thereof has the structure:

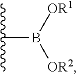

wherein R¹ and R² are each independently selected from —H and substituted or unsubstituted (C₁-C₂₀)hydrocarbyl interrupted by 0, 1, 2, or 3 groups independently chosen from —O—, —S—, and substituted or unsubstituted —NH—, or wherein R¹ and R² together form a substituted or unsubstituted (C₁-C₂₀)hydrocarbylene interrupted by 0, 1, 2, or 3 groups independently chosen from —O—, —S—, and substituted or unsubstituted —NH—.

Embodiment 20 provides the method of Embodiment 19, wherein R¹ and R² are each independently selected from —H and (C₁-C₂₀)alkyl, or wherein R¹ and R² together form a substituted or unsubstituted (C₂-C₂₀)alkylene.

Embodiment 21 provides the method of any one of Embodiments 19-20, wherein R¹ and R² are each independently selected from —H and (C₁-C₅)alkyl, or wherein R¹ and R² together form a substituted or unsubstituted ethylene.

Embodiment 22 provides the method of any one of Embodiments 1-21, wherein the amine group is directly bonded to the silica.

Embodiment 23 provides the method of any one of Embodiments 1-22, wherein the amine group is bonded to the silica via a substituted or unsubstituted (C₁-C₂₀)hydrocarbylene linker, L¹, wherein the (C₁-C₂₀)hydrocarbylene is interrupted with 0, 1, 2, or 3 groups independently chosen from —O—, —S—, and substituted or unsubstituted —NH—.

Embodiment 24 provides the method of Embodiment 23, wherein L¹ is (C₁-C₂₀)alkylene.

Embodiment 25 provides the method of any one of Embodiments 23-24, wherein L¹ is (C₁-C₅)alkylene.

Embodiment 26 provides the method of any one of Embodiments 23-25, wherein L¹ is propylene.

Embodiment 27 provides the method of any one of Embodiments 23-26, wherein the silica bonded to the crosslinking group has the structure:

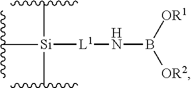

wherein R¹ and R² are each independently selected from —H and substituted or unsubstituted (C₁-C₂₀)hydrocarbyl interrupted by 0, 1, 2, or 3 groups independently chosen from —O—, —S—, and substituted or unsubstituted —NH—, or wherein R¹ and R² together form a substituted or unsubstituted (C₁-C₂₀)hydrocarbylene interrupted by 0, 1, 2, or 3 groups independently chosen from —O—, —S—, and substituted or unsubstituted —NH—.

Embodiment 28 provides the method of any one of Embodiments 1-27, wherein the boronic acid or ester thereof is directly bonded to the amine group.

Embodiment 29 provides the method of any one of Embodiments 1-28, wherein the boronic acid or ester thereof is bonded to the amine group via a substituted or unsubstituted (C₁-C₂₀)hydrocarbylene linker, L², wherein the (C₁-C₂₀)hydrocarbylene is interrupted with 0, 1, 2, or 3 groups independently chosen from —O—, —S—, and substituted or unsubstituted —NH—.

Embodiment 30 provides the method of Embodiment 29, wherein L² is (C₆-C₁₀)aryl(C₁-C₁₀)alkyl.

Embodiment 31 provides the method of any one of Embodiments 29-30, wherein L² is phenyl(C₁-C₅)alkyl.

Embodiment 32 provides the method of any one of Embodiments 29-31, wherein L² is phenylmethyl.

Embodiment 33 provides the method of any one of Embodiments 29-32, wherein the silica bonded to the crosslinking group has the structure:

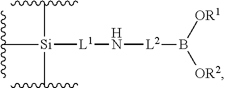

wherein
L¹ is chosen from a bond and a substituted or unsubstituted (C₁-C₂₀)hydrocarbylene interrupted with 0, 1, 2, or 3 groups independently chosen from —O—, —S—, and substituted or unsubstituted —NH—, and
R¹ and R² are each independently selected from —H and substituted or unsubstituted (C₁-C₂₀)hydrocarbyl interrupted by 0, 1, 2, or 3 groups independently chosen from —O—, —S—, and substituted or unsubstituted —NH—, or wherein R¹ and R² together form a substituted or unsubstituted (C₁-C₂₀)hydrocarbylene interrupted by 0, 1, 2, or 3 groups independently chosen from —O—, —S—, and substituted or unsubstituted —NH—.

Embodiment 34 provides the method of any one of Embodiments 1-33, wherein the boronic acid or ester thereof is bonded to the amine group via a mono- or poly-aminoalkyl linker, L³.

Embodiment 35 provides the method of Embodiment 34, wherein L³ is chosen from a —(NH—(C₁-C₅)alkyl)ₙ- group and a —(C₁-C₅)alkyl-(NH—(C₁-C₅)alkyl)ₙ- group, wherein the —NH— is substituted or unsubstituted and n is about 1 to about 10,000.

Embodiment 36 provides the method of any one of Embodiments 34-35, wherein L³ is chosen from a —(NH-ethylene)ₙ- group and a -ethylene-(ethylene)ₙ- group, wherein n is about 1 to about 10,000.

Embodiment 37 provides the method of any one of Embodiments 34-36, wherein the silica bonded to the crosslinking group has the structure:

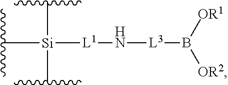

wherein
L¹ is chosen from a bond and a substituted or unsubstituted (C₁-C₂₀)hydrocarbylene interrupted with 0, 1, 2, or 3 groups independently chosen from —O—, —S—, and substituted or unsubstituted —NH—, and
R¹ and R² are each independently selected from —H and substituted or unsubstituted (C₁-C₂₀)hydrocarbyl interrupted by 0, 1, 2, or 3 groups independently chosen from —O—, —S—, and substituted or unsubstituted —NH—, or wherein R¹ and R² together form a substituted or unsubstituted (C₁-C₂₀)hydrocarbylene interrupted by 0, 1, 2, or 3 groups independently chosen from —O—, —S—, and substituted or unsubstituted —NH—.

Embodiment 38 provides the method of any one of Embodiments 34-37, wherein the silica bonded to the crosslinking group has the structure:

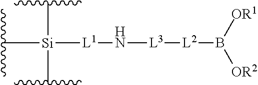

wherein
L¹ is chosen from a bond and a substituted or unsubstituted (C₁-C₂₀)hydrocarbylene interrupted with 0, 1, 2, or 3 groups independently chosen from —O—, —S—, and substituted or unsubstituted —NH—,
L² is chosen from a bond and a substituted or unsubstituted (C₁-C₂₀)hydrocarbylene linker interrupted with 0, 1, 2, or 3 groups independently chosen from —O—, —S—, and substituted or unsubstituted —NH—, and
R¹ and R² are each independently selected from —H and substituted or unsubstituted (C₁-C₂₀)hydrocarbyl interrupted by 0, 1, 2, or 3 groups independently chosen from —O—, —S—, and substituted or unsubstituted —NH—, or wherein R¹ and R² together form a substituted or unsubstituted (C₁-C₂₀)hydrocarbylene interrupted by 0, 1, 2, or 3 groups independently chosen from —O—, —S—, and substituted or unsubstituted —NH—.

Embodiment 39 provides the method of any one of Embodiments 34-38, wherein the silica bonded to the crosslinking group has the structure:

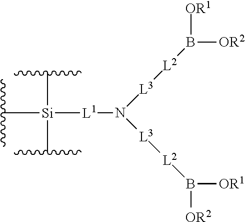

wherein
L¹ is chosen from a bond and a substituted or unsubstituted (C₁-C₂₀)hydrocarbylene interrupted with 0, 1, 2, or 3 groups independently chosen from —O—, —S—, and substituted or unsubstituted —NH—,
at each occurrence, L² is chosen from a bond and a substituted or unsubstituted (C₁-C₂₀)hydrocarbylene linker interrupted with 0, 1, 2, or 3 groups independently chosen from —O—, —S—, and substituted or unsubstituted —NH—, and
at each occurrence, R¹ and R² are each independently selected from —H and substituted or unsubstituted (C₁-C₂₀)hydrocarbyl interrupted by 0, 1, 2, or 3 groups independently chosen from —O—, —S—, and substituted or unsubstituted —NH—, or wherein R¹ and R² together form a substituted or unsubstituted (C₁-C₂₀)hydrocarbylene interrupted by 0, 1, 2, or 3 groups independently chosen from —O—, —S—, and substituted or unsubstituted —NH—.

Embodiment 40 provides the method of any one of Embodiments 1-39, wherein the silica bonded to the crosslinking group has the structure:

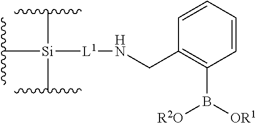

wherein
L¹ is chosen from a bond and a substituted or unsubstituted (C₁-C₂₀)hydrocarbylene interrupted with 0, 1, 2, or 3 groups independently chosen from —O—, —S—, and substituted or unsubstituted —NH—, and
R¹ and R² are each independently selected from —H and substituted or unsubstituted (C₁-C₂₀)hydrocarbyl interrupted by 0, 1, 2, or 3 groups independently chosen from —O—, —S—, and substituted or unsubstituted —NH—, or wherein R¹ and R² together form a substituted or unsubstituted (C₁-C₂₀)hydrocarbylene interrupted by 0, 1, 2, or 3 groups independently chosen from —O—, —S—, and substituted or unsubstituted —NH—.

Embodiment 41 provides the method of any one of Embodiments 1-40, wherein the silica bonded to the crosslinking group has the structure:

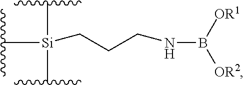

wherein
R¹ and R² are each independently selected from —H and substituted or unsubstituted (C₁-C₂₀)hydrocarbyl interrupted by 0, 1, 2, or 3 groups independently chosen from —O—, —S—, and substituted or unsubstituted —NH—, or wherein R¹ and R² together form a substituted or unsubstituted (C₁-C₂₀)hydrocarbylene interrupted by 0, 1, 2, or 3 groups independently chosen from —O—, —S—, and substituted or unsubstituted —NH—.

Embodiment 42 provides the method of any one of Embodiments 1-41, wherein the silica bonded to the crosslinking group has the structure:

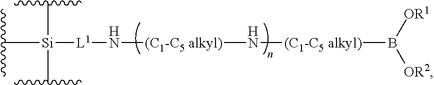

wherein
L¹ is chosen from a bond and a substituted or unsubstituted (C₁-C₂₀)hydrocarbylene interrupted with 0, 1, 2, or 3 groups independently chosen from —O—, —S—, and substituted or unsubstituted —NH—,
R¹ and R² are each independently selected from —H and substituted or unsubstituted (C₁-C₂₀)hydrocarbyl interrupted by 0, 1, 2, or 3 groups independently chosen from —O—, —S—, and substituted or unsubstituted —NH—, or wherein R¹ and R² together form a substituted or unsubstituted (C₁-C₂₀)hydrocarbylene interrupted by 0, 1, 2, or 3 groups independently chosen from —O—, —S—, and substituted or unsubstituted —NH—, and
n is about 1 to about 10,000.

Embodiment 43 provides the method of any one of Embodiments 1-42, wherein the silica bonded to the crosslinking group has the structure:

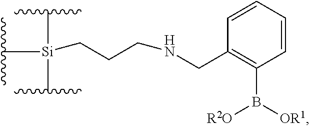

wherein
R¹ and R² are each independently selected from —H and substituted or unsubstituted (C₁-C₂₀)hydrocarbyl interrupted by 0, 1, 2, or 3 groups independently chosen from —O—, —S—, and substituted or unsubstituted —NH—, or wherein R¹ and R² together form a substituted or unsubstituted (C₁-C₂₀)hydrocarbylene interrupted by 0, 1, 2, or 3 groups independently chosen from —O—, —S—, and substituted or unsubstituted —NH—.

Embodiment 44 provides the method of any one of Embodiments 1-43, wherein the silica bonded to the crosslinking group has the structure:

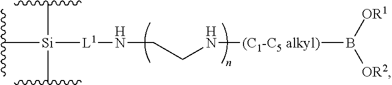

wherein
L¹ is chosen from a bond and a substituted or unsubstituted (C₁-C₂₀)hydrocarbylene interrupted with 0, 1, 2, or 3 groups independently chosen from —O—, —S—, and substituted or unsubstituted —NH—, and
R¹ and R² are each independently selected from —H and substituted or unsubstituted (C₁-C₂₀)hydrocarbyl interrupted by 0, 1, 2, or 3 groups independently chosen from —O—, —S—, and substituted or unsubstituted —NH—, or wherein R¹ and R² together form a substituted or unsubstituted (C₁-C₂₀)hydrocarbylene interrupted by 0, 1, 2, or 3 groups independently chosen from —O—, —S—, and substituted or unsubstituted —NH—.

Embodiment 45 provides the method of any one of Embodiments 1-44, wherein the silica bonded to the crosslinking group has the structure:

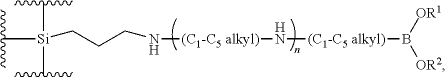

wherein
R¹ and R² are each independently selected from —H and substituted or unsubstituted (C₁-C₂₀)hydrocarbyl interrupted by 0, 1, 2, or 3 groups independently chosen from —O—, —S—, and substituted or unsubstituted —NH—, or wherein R¹ and R² together form a substituted or unsubstituted (C₁-C₂₀)hydrocarbylene interrupted by 0, 1, 2, or 3 groups independently chosen from —O—, —S—, and substituted or unsubstituted —NH—, and
n is about 1 to about 10,000.

Embodiment 46 provides the method of any one of Embodiments 1-45, wherein the silica bonded to the crosslinking group has the structure:

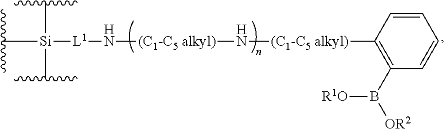

wherein
L¹ is chosen from a bond and a substituted or unsubstituted (C₁-C₂₀)hydrocarbylene interrupted with 0, 1, 2, or 3 groups independently chosen from —O—, —S—, and substituted or unsubstituted —NH—,
R¹ and R² are each independently selected from —H and substituted or unsubstituted (C₁-C₂₀)hydrocarbyl interrupted by 0, 1, 2, or 3 groups independently chosen from —O—, —S—, and substituted or unsubstituted —NH—, or wherein R¹ and R² together form a substituted or unsubstituted (C₁-C₂₀)hydrocarbylene interrupted by 0, 1, 2, or 3 groups independently chosen from —O—, —S—, and substituted or unsubstituted —NH—, and
n is about 1 to about 10,000.

Embodiment 47 provides the method of any one of Embodiments 1-46, wherein the silica bonded to the crosslinking group has the structure:

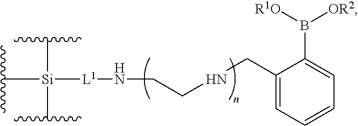

wherein
L¹ is chosen from a bond and a substituted or unsubstituted (C₁-C₂₀)hydrocarbylene interrupted with 0, 1, 2, or 3 groups independently chosen from —O—, —S—, and substituted or unsubstituted —NH—,
R¹ and R² are each independently selected from —H and substituted or unsubstituted (C₁-C₂₀)hydrocarbyl interrupted by 0, 1, 2, or 3 groups independently chosen from —O—, —S—, and substituted or unsubstituted —NH—, or wherein R¹ and R² together form a substituted or unsubstituted (C₁-C₂₀)hydrocarbylene interrupted by 0, 1, 2, or 3 groups independently chosen from —O—, —S—, and substituted or unsubstituted —NH—, and
n is about 1 to about 10,000.

Embodiment 48 provides the method of any one of Embodiments 1-47, wherein the silica bonded to the crosslinking group has the structure:

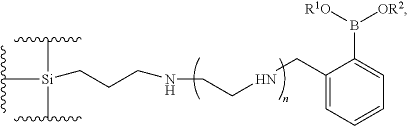

wherein
R¹ and R² are each independently selected from —H and substituted or unsubstituted (C₁-C₂₀)hydrocarbyl interrupted by 0, 1, 2, or 3 groups independently chosen from —O—, —S—, and substituted or unsubstituted —NH—, or wherein R¹ and R² together form a substituted or unsubstituted (C₁-C₂₀)hydrocarbylene interrupted by 0, 1, 2, or 3 groups independently chosen from —O—, —S—, and substituted or unsubstituted —NH—, and
n is about 1 to about 10,000.

Embodiment 49 provides the method of any one of Embodiments 1-48, wherein the polysaccharide viscosifier is about 0.01 wt % to about 40 wt % of the composition.

Embodiment 50 provides the method of any one of Embodiments 1-49, wherein the polysaccharide viscosifier is about 1 wt % to about 20 wt % of the composition.

Embodiment 51 provides the method of any one of Embodiments 1-50, wherein the polysaccharide viscosifier is at least one of poly(acrylic acid) or (C₁-C₅)alkyl esters thereof, poly(methacrylic acid) or (C₁-C₅)alkyl esters thereof, poly(vinyl acetate), poly(vinyl alcohol), poly(ethylene glycol), poly(vinyl pyrrolidone), polyacrylamide, poly (hydroxyethyl methacrylate), alginate, chitosan, curdlan, dextran, derivatized dextran, emulsan, a galactoglucopolysaccharide, gellan, glucuronan, N-acetyl-glucosamine, N-acetyl-heparosan, hyaluronic acid, kefiran, lentinan, levan, mauran, pullulan, scleroglucan, schizophyllan, stewartan, succinoglycan, xanthan, diutan, welan, starch, derivatized starch, tamarind, tragacanth, guar gum, derivatized guar gum, gum ghatti, gum arabic, locust bean gum, cellulose, and derivatized cellulose.

Embodiment 52 provides the method of any one of Embodiments 1-51, wherein the polysaccharide viscosifier is at least one of guar gum and a guar gum derivative.

Embodiment 53 provides the method of any one of Embodiments 1-52, wherein the polysaccharide viscosifier is at least one of guar gum, hydroxypropyl guar, carboxymethyl guar, or carboxymethyl hydroxypropyl guar.

Embodiment 54 provides the method of any one of Embodiments 1-53, further comprising combining the composition with an aqueous or oil-based fluid comprising a drilling fluid, stimulation fluid, fracturing fluid, spotting fluid, clean-up fluid, completion fluid, remedial treatment fluid, abandonment fluid, pill, acidizing fluid, cementing fluid, packer fluid, logging fluid, or a combination thereof, to form a mixture, wherein the placing the composition in the subterranean formation comprises placing the mixture in the subterranean formation.

Embodiment 55 provides the method of any one of Embodiments 1-54, wherein at least one of prior to, during, and after the placing of the composition in the subterranean formation, the composition is used in the subterranean formation, at least one of alone and in combination with other materials, as a drilling fluid, stimulation fluid, fracturing fluid, spotting fluid, clean-up fluid, completion fluid, remedial treatment fluid, abandonment fluid, pill, acidizing fluid, cementing fluid, packer fluid, logging fluid, or a combination thereof.

Embodiment 56 provides the method of any one of Embodiments 1-55, wherein the composition further comprises water, saline, aqueous base, oil, organic solvent, synthetic fluid oil phase, aqueous solution, alcohol or polyol, cellulose, starch, alkalinity control agent, acidity control agent, density control agent, density modifier, emulsifier, dispersant, polymeric stabilizer, crosslinking agent, polyacrylamide, polymer or combination of polymers, antioxidant, heat stabilizer, foam control agent, solvent, diluent, plasticizer, filler or inorganic particle, pigment, dye, precipitating agent, oil-wetting agent, set retarding additive, surfactant, corrosion inhibitor, gas, weight reducing additive, heavy-weight additive, lost circulation material, filtration control additive, salt, fiber, thixotropic additive, breaker, crosslinker, gas, rheology modifier, curing accelerator, curing retarder, pH modifier, chelating agent, scale inhibitor, enzyme, resin, water control material, polymer, oxidizer, a marker, Portland cement, pozzolana cement, gypsum cement, high alumina content cement, slag cement, silica cement, fly ash, metakaolin, shale, zeolite, a crystalline silica compound, amorphous silica, fibers, a hydratable clay, microspheres, pozzolan lime, a chelator, a hydrogen sulfide scavenger, a breaker activator, or a combination thereof.

Embodiment 57 provides the method of any one of Embodiments 1-56, wherein the placing of the composition in the subterranean formation comprises fracturing at least part of the subterranean formation to form at least one subterranean fracture.

Embodiment 58 provides the method of any one of Embodiments 1-57, wherein the composition further comprises a proppant, a resin-coated proppant, gravel, a resin-coated gravel, or a combination thereof.

Embodiment 59 provides the method of any one of Embodiments 1-58, wherein the crosslinker comprises a payload material.

Embodiment 60 provides the method of Embodiment 59, wherein the silica is a hollow shell in the crosslinker, wherein the payload material is inside the hollow shell.

Embodiment 61 provides the method of any one of Embodiments 59-60, further comprising using the composition to deposit at least part of the payload material in the subterranean formation.

Embodiment 62 provides the method of Embodiment 61, wherein the at least part of the payload material is deposited in a subterranean fracture.

Embodiment 63 provides the method of any one of Embodiments 59-62, wherein the payload material comprises a proppant, a resin-coated proppant, a curable material, an encapsulated resin, a resin, a Portland cement, a pozzolana cement, a gypsum cement, a high alumina content cement, a slag cement, a silica cement, a cementitous kiln dust, fly ash, metakaolin, shale, zeolite, a set retarding additive, a surfactant, a corrosion inhibitor, a gas, an accelerator, a weight reducing additive, a heavy-weight additive, a lost circulation material, a filtration control additive, a dispersant, a crystalline silica compound, an amorphous silica, a salt, a fiber, a hydratable clay, a microsphere, pozzolan lime, a thixotropic additive, water, an aqueous base, an aqueous acid, an alcohol or polyol, a cellulose, a starch, an alkalinity control agent, an acidity control agent, a density control agent, a density modifier, an emulsifier, a polymeric stabilizer, a crosslinking agent, a polyacrylamide, a polymer or combination of polymers, an antioxidant, a heat stabilizer, a foam control agent, a solvent, a diluent, a plasticizer, a filler or inorganic particle, a pigment, a dye, a precipitating agent, a rheology modifier, a chelator, a hydrogen sulfide scavenger, a breaker, a breaker activator, or a combination thereof.

Embodiment 64 provides the method of any one of Embodiments 1-63, wherein the placing of the composition in the subterranean formation comprises pumping the composition through a tubular disposed in a wellbore and into the subterranean formation.

Embodiment 65 provides the method of any one of Embodiments 1-64, wherein the placing of the composition in the subterranean formation comprises pumping the composition through a drill string disposed in a wellbore, through a drill bit at a downhole end of the drill string, and back above-surface through an annulus.

Embodiment 66 provides the method of Embodiment 65, further comprising processing the composition exiting the annulus with at least one fluid processing unit to generate a cleaned composition and recirculating the cleaned composition through the wellbore.

Embodiment 67 provides a system for performing the method of any one of Embodiments 1-66, the system comprising:

a tubular disposed in the subterranean formation; and

a pump configured to pump the composition in the subterranean formation through the tubular.

Embodiment 68 provides a system for performing the method of any one of Embodiments 1-66, the system comprising:

a drill string disposed in a wellbore, the drill string comprising a drill bit at a downhole end of the drill string;

an annulus between the drill string and the wellbore; and

a pump configured to circulate the composition through the drill string, through the drill bit, and back above-surface through the annulus.

Embodiment 69 provides a method of treating a subterranean formation, the method comprising:

placing in a subterranean formation a composition comprising
a polysaccharide viscosifier; and
a nanoparticle crosslinker comprising a silica bonded to at least one crosslinking group, the silica bonded to the crosslinking group having the structure

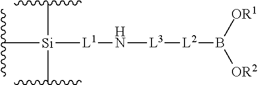

wherein
   L¹ is chosen from a bond and a substituted or unsubstituted (C₁-C₂₀)hydrocarbylene interrupted with 0, 1, 2, or 3 groups independently chosen from —O—, —S—, and substituted or unsubstituted —NH—,
   L² is chosen from a bond and a substituted or unsubstituted (C₁-C₂₀)hydrocarbylene linker interrupted with 0, 1, 2, or 3 groups independently chosen from —O—, —S—, and substituted or unsubstituted —NH—,
   L³ is chosen from a bond, a —(NH—(C₁-C₅)alkyl)ₙ- group, and a —(C₁-C₅)alkyl-(NH—(C₁-C₅)alkyl)ₙ- group, wherein n is about 1 to about 10,000, and
   R¹ and R² are each independently selected from —H and substituted or unsubstituted (C₁-C₂₀)hydrocarbyl interrupted by 0, 1, 2, or 3 groups independently chosen from —O—, —S—, and substituted or unsubstituted —NH—, or wherein R¹ and R² together form a substituted or unsubstituted (C₁-C₂₀)hydrocarbylene interrupted by 0, 1, 2, or 3 groups independently chosen from —O—, —S—, and substituted or unsubstituted —NH—; and

crosslinking the polysaccharide viscosifier with the nanoparticle crosslinker.

Embodiment 70 provides a system comprising:

a composition comprising
a polysaccharide viscosifier; and
a crosslinker comprising a silica bonded to at least one crosslinking group that comprises at least one amine group comprising at least one of a boronic acid and an ester thereof; and

a subterranean formation comprising the composition therein.

Embodiment 71 provides the system of Embodiment 70, further comprising

a drill string disposed in a wellbore, the drill string comprising a drill bit at a downhole end of the drill string;

an annulus between the drill string and the wellbore; and

a pump configured to circulate the composition through the drill string, through the drill bit, and back above-surface through the annulus.

Embodiment 72 provides the system of any one of Embodiments 70-71, further comprising a fluid processing unit configured to process the composition exiting the annulus to generate a cleaned drilling fluid for recirculation through the wellbore.

Embodiment 73 provides the system of any one of Embodiments 70-72, further comprising

a tubular disposed in the subterranean formation; and

a pump configured to pump the composition in the subterranean formation through the tubular.

Embodiment 74 provides a composition for treatment of a subterranean formation, the composition comprising:

a polysaccharide viscosifier; and

a crosslinker comprising a silica bonded to at least one crosslinking group that comprises at least one amine group comprising at least one of a boronic acid and an ester thereof.

Embodiment 75 provides the composition of Embodiment 74, wherein the composition further comprises a downhole fluid.

Embodiment 76 provides the composition of any one of Embodiments 74-75, wherein the composition is a composition for fracturing of a subterranean formation.

Embodiment 77 provides a crosslinked reaction product of the composition of any one of Embodiments 74-76.

Embodiment 78 provides a composition for treatment of a subterranean formation, the composition comprising:

a polysaccharide viscosifier; and

a nanoparticle crosslinker comprising a silica bonded to at least one crosslinking group, the silica bonded to the crosslinking group having the structure

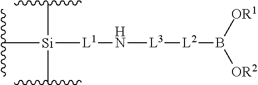

wherein
L¹ is chosen from a bond and a substituted or unsubstituted (C₁-C₂₀)hydrocarbylene interrupted with 0, 1, 2, or 3 groups independently chosen from —O—, —S—, and substituted or unsubstituted —NH—,
L² is chosen from a bond and a substituted or unsubstituted (C₁-C₂₀)hydrocarbylene linker interrupted with 0, 1, 2, or 3 groups independently chosen from —O—, —S—, and substituted or unsubstituted —NH—,
L³ is chosen from a bond, a —(NH—(C₁-C₅)alkyl)ₙ- group, and a —(C₁-C₅)alkyl-(NH—(C₁-C₅)alkyl)ₙ- group, wherein n is about 1 to about 10,000, and
R¹ and R² are each independently selected from —H and substituted or unsubstituted (C₁-C₂₀)hydrocarbyl interrupted by 0, 1, 2, or 3 groups independently chosen from —O—, —S—, and substituted or unsubstituted —NH—, or wherein R¹ and R² together form a substituted or unsubstituted (C₁-C₂₀)hydrocarbylene interrupted by 0, 1, 2, or 3 groups independently chosen from —O—, —S—, and substituted or unsubstituted —NH—.

Embodiment 79 provides a method of preparing a composition for treatment of a subterranean formation, the method comprising:

forming a composition comprising
a polysaccharide viscosifier; and
a crosslinker comprising a silica bonded to at least one crosslinking group that comprises at least one amine group comprising at least one of a boronic acid and an ester thereof.

Embodiment 80 provides the composition, method, or system of any one or any combination of Embodiments 1-79 optionally configured such that all elements or options recited are available to use or select from.

1.-79. (canceled)

80. A method of treating a subterranean formation, comprising:
placing a composition into a subterranean formation, the composition comprising:
a polysaccharide viscosifier; and
a crosslinker comprising a silica bonded to a crosslinking group that comprises an amine group comprising at least one of a boronic acid, an ester thereof, or a combination thereof.

81. The method of claim 80, wherein the amine group is bonded to the silica via a substituted or unsubstituted (C₁-C₂₀)hydrocarbylene linker, L¹, wherein the (C₁-C₂₀)hydrocarbylene is interrupted with 0, 1, 2, or 3 groups independently chosen from —O—, —S—, and substituted or unsubstituted —NH—.

82. The method of claim 81, wherein L¹ is (C₁-C₅)alkylene.

83. The method of claim 81, wherein the silica bonded to the crosslinking group has the structure: 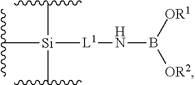
wherein R¹ and R² are each independently selected from —H and substituted or unsubstituted (C₁-C₂₀)hydrocarbyl interrupted by 0, 1, 2, or 3 groups independently chosen from —O—, —S—, and substituted or unsubstituted —NH—, or wherein R¹ and R² together form a substituted or unsubstituted (C₁-C₂₀)hydrocarbylene interrupted by 0, 1, 2, or 3 groups independently chosen from —O—, —S—, and substituted or unsubstituted —NH—.

84. The method of claim 80, wherein the boronic acid or ester thereof is bonded to the amine group via a substituted or unsubstituted (C₁-C₂₀)hydrocarbylene linker, L², and wherein the (C₁-C₂₀)hydrocarbylene is interrupted with 0, 1, 2, or 3 groups independently chosen from —O—, —S—, and substituted or unsubstituted —NH—.

85. The method of claim 84, wherein the silica bonded to the crosslinking group has the structure: 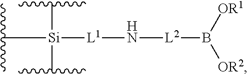
wherein:
L¹ is chosen from a bond and a substituted or unsubstituted (C₁-C₂₀)hydrocarbylene interrupted with 0, 1, 2, or 3 groups independently chosen from —O—, —S—, and substituted or unsubstituted —NH—, and
R¹ and R² are each independently selected from —H and substituted or unsubstituted (C₁-C₂₀)hydrocarbyl interrupted by 0, 1, 2, or 3 groups independently chosen from —O—, —S—, and substituted or unsubstituted —NH—, or wherein R¹ and R² together form a substituted or unsubstituted (C₁-C₂₀)hydrocarbylene interrupted by 0, 1, 2, or 3 groups independently chosen from —O—, —S—, and substituted or unsubstituted —NH—.

86. The method of claim 80, wherein the boronic acid or ester thereof is bonded to the amine group via a mono- or poly-aminoalkyl linker, L³, and wherein the silica bonded to the crosslinking group has the structure: 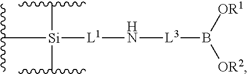
wherein:
L¹ is chosen from a bond and a substituted or unsubstituted (C₁-C₂₀)hydrocarbylene interrupted with 0, 1, 2, or 3 groups independently chosen from —O—, —S—, and substituted or unsubstituted —NH—, and
R¹ and R² are each independently selected from —H and substituted or unsubstituted (C₁-C₂₀)hydrocarbyl interrupted by 0, 1, 2, or 3 groups independently chosen from —O—, —S—, and substituted or unsubstituted —NH—, or wherein R¹ and R² together form a substituted or unsubstituted (C₁-C₂₀)hydrocarbylene interrupted by 0, 1, 2, or 3 groups independently chosen from —O—, —S—, and substituted or unsubstituted —NH—.

87. The method of claim 80, wherein the boronic acid or ester thereof is bonded to the amine group via a mono- or poly-aminoalkyl linker, L³, and wherein the silica bonded to the crosslinking group has the structure: 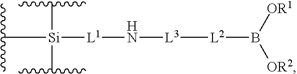
wherein
L¹ is chosen from a bond and a substituted or unsubstituted (C₁-C₂₀)hydrocarbylene interrupted with 0, 1, 2, or 3 groups independently chosen from —O—, —S—, and substituted or unsubstituted —NH—,
L² is chosen from a bond and a substituted or unsubstituted (C₁-C₂₀)hydrocarbylene linker interrupted with 0, 1, 2, or 3 groups independently chosen from —O—, —S—, and substituted or unsubstituted —NH—, and
R¹ and R² are each independently selected from —H and substituted or unsubstituted (C₁-C₂₀)hydrocarbyl interrupted by 0, 1, 2, or 3 groups independently chosen from —O—, —S—, and substituted or unsubstituted —NH—, or wherein R¹ and R² together form a substituted or unsubstituted (C₁-C₂₀)hydrocarbylene interrupted by 0, 1, 2, or 3 groups independently chosen from —O—, —S—, and substituted or unsubstituted —NH—.

88. The method of claim 80, wherein the boronic acid or ester thereof is bonded to the amine group via a mono- or poly-aminoalkyl linker, L³, and wherein the silica bonded to the crosslinking group has the structure: 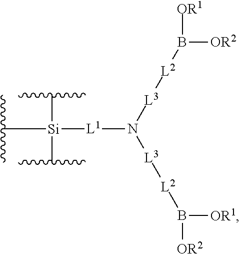
wherein:
L¹ is chosen from a bond and a substituted or unsubstituted (C₁-C₂₀)hydrocarbylene interrupted with 0, 1, 2, or 3 groups independently chosen from —O—, —S—, and substituted or unsubstituted —NH—,
at each occurrence, L² is chosen from a bond and a substituted or unsubstituted (C₁-C₂₀)hydrocarbylene linker interrupted with 0, 1, 2, or 3 groups independently chosen from —O—, —S—, and substituted or unsubstituted —NH—, and
at each occurrence, R¹ and R² are each independently selected from —H and substituted or unsubstituted (C₁-C₂₀)hydrocarbyl interrupted by 0, 1, 2, or 3 groups independently chosen from —O—, —S—, and substituted or unsubstituted —NH—, or wherein R¹ and R² together form a substituted or unsubstituted (C₁-C₂₀)hydrocarbylene interrupted by 0, 1, 2, or 3 groups independently chosen from —O—, —S—, and substituted or unsubstituted —NH—.

89. The method of claim 80, wherein the silica bonded to the crosslinking group has the structure: 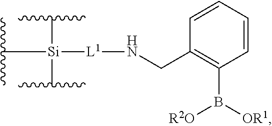
wherein:
L¹ is chosen from a bond and a substituted or unsubstituted (C₁-C₂₀)hydrocarbylene interrupted with 0, 1, 2, or 3 groups independently chosen from —O—, —S—, and substituted or unsubstituted —NH—, and
R¹ and R² are each independently selected from —H and substituted or unsubstituted (C₁-C₂₀)hydrocarbyl interrupted by 0, 1, 2, or 3 groups independently chosen from —O—, —S—, and substituted or unsubstituted —NH—, or wherein R¹ and R² together form a substituted or unsubstituted (C₁-C₂₀)hydrocarbylene interrupted by 0, 1, 2, or 3 groups independently chosen from —O—, —S—, and substituted or unsubstituted —NH—.

90. The method of claim 80, wherein the silica bonded to the crosslinking group has the structure: 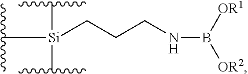
wherein:
R¹ and R² are each independently selected from —H and substituted or unsubstituted (C₁-C₂₀)hydrocarbyl interrupted by 0, 1, 2, or 3 groups independently chosen from —O—, —S—, and substituted or unsubstituted —NH—, or wherein R¹ and R² together form a substituted or unsubstituted (C₁-C₂₀)hydrocarbylene interrupted by 0, 1, 2, or 3 groups independently chosen from —O—, —S—, and substituted or unsubstituted —NH—.

91. The method of claim 80, wherein the silica bonded to the crosslinking group has the structure: 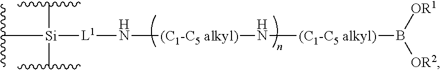
wherein:
L¹ is chosen from a bond and a substituted or unsubstituted (C₁-C₂₀)hydrocarbylene interrupted with 0, 1, 2, or 3 groups independently chosen from —O—, —S—, and substituted or unsubstituted —NH—,
R¹ and R² are each independently selected from —H and substituted or unsubstituted (C₁-C₂₀)hydrocarbyl interrupted by 0, 1, 2, or 3 groups independently chosen from —O—, —S—, and substituted or unsubstituted —NH—, or wherein R¹ and R² together form a substituted or unsubstituted (C₁-C₂₀)hydrocarbylene interrupted by 0, 1, 2, or 3 groups independently chosen from —O—, —S—, and substituted or unsubstituted —NH—, and
n is about 1 to about 10,000.

92. The method of claim 80, wherein the silica bonded to the crosslinking group has the structure: 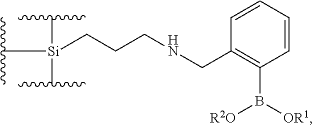
wherein:
R¹ and R² are each independently selected from —H and substituted or unsubstituted (C₁-C₂₀)hydrocarbyl interrupted by 0, 1, 2, or 3 groups independently chosen from —O—, —S—, and substituted or unsubstituted —NH—, or wherein R¹ and R² together form a substituted or unsubstituted (C₁-C₂₀)hydrocarbylene interrupted by 0, 1, 2, or 3 groups independently chosen from —O—, —S—, and substituted or unsubstituted —NH—.

93. The method of claim 80, wherein the silica bonded to the crosslinking group has the structure: 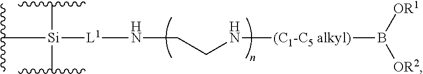
wherein:
L¹ is chosen from a bond and a substituted or unsubstituted (C₁-C₂₀)hydrocarbylene interrupted with 0, 1, 2, or 3 groups independently chosen from —O—, —S—, and substituted or unsubstituted —NH—, and
R¹ and R² are each independently selected from —H and substituted or unsubstituted (C₁-C₂₀)hydrocarbyl interrupted by 0, 1, 2, or 3 groups independently chosen from —O—, —S—, and substituted or unsubstituted —NH—, or wherein R¹ and R² together form a substituted or unsubstituted (C₁-C₂₀)hydrocarbylene interrupted by 0, 1, 2, or 3 groups independently chosen from —O—, —S—, and substituted or unsubstituted —NH—.

94. The method of claim 80, wherein the silica bonded to the crosslinking group has the structure: 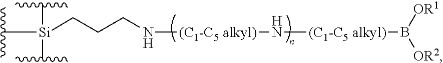
wherein:
R¹ and R² are each independently selected from —H and substituted or unsubstituted (C₁-C₂₀)hydrocarbyl interrupted by 0, 1, 2, or 3 groups independently chosen from —O—, —S—, and substituted or unsubstituted —NH—, or wherein R¹ and R² together form a substituted or unsubstituted (C₁-C₂₀)hydrocarbylene interrupted by 0, 1, 2, or 3 groups independently chosen from —O—, —S—, and substituted or unsubstituted —NH—, and
n is about 1 to about 10,000.

95. The method of claim 80, wherein the silica bonded to the crosslinking group has the structure: 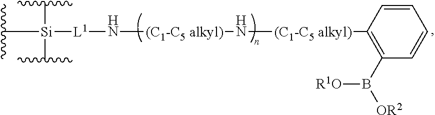
wherein:
L¹ is chosen from a bond and a substituted or unsubstituted (C₁-C₂₀)hydrocarbylene interrupted with 0, 1, 2, or 3 groups independently chosen from —O—, —S—, and substituted or unsubstituted —NH—,
R¹ and R² are each independently selected from —H and substituted or unsubstituted (C₁-C₂₀)hydrocarbyl interrupted by 0, 1, 2, or 3 groups independently chosen from —O—, —S—, and substituted or unsubstituted —NH—, or wherein R¹ and R² together form a substituted or unsubstituted (C₁-C₂₀)hydrocarbylene interrupted by 0, 1, 2, or 3 groups independently chosen from —O—, —S—, and substituted or unsubstituted —NH—, and
n is about 1 to about 10,000.

96. The method of claim 80, wherein the silica bonded to the crosslinking group has the structure: 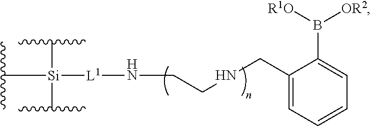
wherein:
L¹ is chosen from a bond and a substituted or unsubstituted (C₁-C₂₀)hydrocarbylene interrupted with 0, 1, 2, or 3 groups independently chosen from —O—, —S—, and substituted or unsubstituted —NH—,
R¹ and R² are each independently selected from —H and substituted or unsubstituted (C₁-C₂₀)hydrocarbyl interrupted by 0, 1, 2, or 3 groups independently chosen from —O—, —S—, and substituted or unsubstituted —NH—, or wherein R¹ and R² together form a substituted or unsubstituted (C₁-C₂₀)hydrocarbylene interrupted by 0, 1, 2, or 3 groups independently chosen from —O—, —S—, and substituted or unsubstituted —NH—, and
n is about 1 to about 10,000.

97. The method of claim 80, wherein the silica bonded to the crosslinking group has the structure: 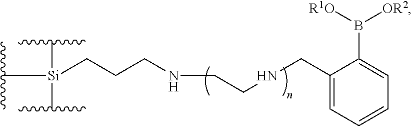
wherein:
R¹ and R² are each independently selected from —H and substituted or unsubstituted (C₁-C₂₀)hydrocarbyl interrupted by 0, 1, 2, or 3 groups independently chosen from —O—, —S—, and substituted or unsubstituted —NH—, or wherein R¹ and R² together form a substituted or unsubstituted (C₁-C₂₀)hydrocarbylene interrupted by 0, 1, 2, or 3 groups independently chosen from —O—, —S—, and substituted or unsubstituted —NH—, and
n is about 1 to about 10,000.

98. A method of treating a subterranean formation, the method comprising:
placing a composition into a subterranean formation, the composition comprising:
a polysaccharide viscosifier; and
a nanoparticle crosslinker comprising a silica bonded to a crosslinking group, the silica bonded to the crosslinking group having the structure: 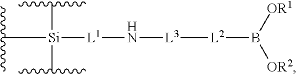
wherein:
L¹ is chosen from a bond and a substituted or unsubstituted (C₁-C₂₀)hydrocarbylene interrupted with 0, 1, 2, or 3 groups independently chosen from —O—, —S—, and substituted or unsubstituted —NH—,
L² is chosen from a bond and a substituted or unsubstituted (C₁-C₂₀)hydrocarbylene linker interrupted with 0, 1, 2, or 3 groups independently chosen from —O—, —S—, and substituted or unsubstituted —NH—,
L³ is chosen from a bond, a —(NH—(C₁-C₅)alkyl)ₙ- group, and a —(C₁-C₅)alkyl-(NH—(C₁-C₅)alkyl)ₙ- group, wherein n is about 1 to about 10,000, and
R¹ and R² are each independently selected from —H and substituted or unsubstituted (C₁-C₂₀)hydrocarbyl interrupted by 0, 1, 2, or 3 groups independently chosen from —O—, —S—, and substituted or unsubstituted —NH—, or wherein R¹ and R² together form a substituted or unsubstituted (C₁-C₂₀)hydrocarbylene interrupted by 0, 1, 2, or 3 groups independently chosen from —O—, —S—, and substituted or unsubstituted —NH—; and
crosslinking the polysaccharide viscosifier with the nanoparticle crosslinker.

99. A composition for treatment of a subterranean formation, comprising:
a polysaccharide viscosifier; and
a nanoparticle crosslinker comprising a silica bonded to a crosslinking group, the silica bonded to the crosslinking group having the structure: 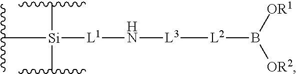
wherein:
L¹ is chosen from a bond and a substituted or unsubstituted (C₁-C₂₀)hydrocarbylene interrupted with 0, 1, 2, or 3 groups independently chosen from —O—, —S—, and substituted or unsubstituted —NH—,
L² is chosen from a bond and a substituted or unsubstituted (C₁-C₂₀)hydrocarbylene linker interrupted with 0, 1, 2, or 3 groups independently chosen from —O—, —S—, and substituted or unsubstituted —NH—,
L³ is chosen from a bond, a —(NH—(C₁-C₅)alkyl)ₙ- group, and a —(C₁-C₅)alkyl-(NH—(C₁-C₅)alkyl)ₙ- group, wherein n is about 1 to about 10,000, and
R¹ and R² are each independently selected from —H and substituted or unsubstituted (C₁-C₂₀)hydrocarbyl interrupted by 0, 1, 2, or 3 groups independently chosen from —O—, —S—, and substituted or unsubstituted —NH—, or wherein R¹ and R² together form a substituted or unsubstituted (C₁-C₂₀)hydrocarbylene interrupted by 0, 1, 2, or 3 groups independently chosen from —O—, —S—, and substituted or unsubstituted —NH—.
